(19) United States
(12) Patent Application Publication
(10) Pub. No.: US 2025/0273697 A1
(43) Pub. Date: Aug. 28, 2025

(54) GAS DIFFUSION ELECTRODES FOR METAL-AIR BATTERIES

(71) Applicant: Form Energy, Inc., Somerville, MA (US)

(72) Inventors: Riley BRANDT, Somerville, PA (US); Malcolm CUMMINGS, Somerville, MA (US); Christopher Evan WOOD, Glenshaw, PA (US)

(21) Appl. No.: 19/060,909

(22) Filed: Feb. 24, 2025

Related U.S. Application Data
(60) Provisional application No. 63/556,698, filed on Feb. 22, 2024.

(51) Int. Cl. H01M 4/88; H01M 4/86; H01M 12/02; H01M 12/06; H01M 12/08

(52) U.S. Cl. CPC H01M 4/8807; H01M 4/8626; H01M 12/02; H01M 12/06; H01M 12/08

(57) ABSTRACT

The present disclosure is generally directed to a discharge cathode of a metal-air battery. A method of fabricating the discharge cathode includes forming a frame of electrically insulating material onto a terminal with a first end portion of the terminal exposed in a window defined by the frame and a second end portion of the terminal outside of the frame. The method includes positioning a gas diffusion electrode (GDE) on the frame with a busbar supported on the GDE and a bus tab extending from the busbar to the window. The method includes connecting the bus tab and the first end portion of the terminal to one another through the window. The method includes, with the bus tab and the terminal connected to one another, hermetically sealing the window.

### CROSS-REFERENCES TO RELATED APPLICATIONS

This application claims the benefit of priority to U.S. Provisional Patent Application 63/556,698 filed Feb. 22, 2024, the entire contents of which are hereby incorporated herein by reference.

### BACKGROUND

Energy storage technologies are playing an increasingly important role in electric power grids. These energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for increased availability, reliability, and/or resiliency with reduced costs in energy storage systems.

### SUMMARY

According to an aspect, a method of fabricating a discharge cathode assembly may include: forming a frame of electrically insulating material onto a terminal with a first end portion of the terminal exposed in a window defined by the frame and a second end portion of the terminal outside of the frame; positioning a gas diffusion electrode (GDE) on the frame with a busbar supported on the GDE and a bus tab extending from the busbar to the window; connecting the bus tab and the first end portion of the terminal to one another through the window; and with the bus tab and the terminal connected to one another, hermetically sealing the window.

In certain implementations, forming the frame of electrically insulating material onto the terminal may include overmolding the frame of electrically insulating material onto the terminal.

In some implementations, the electrically insulating material of the frame may be plastic.

In certain implementations, positioning the GDE on the frame may include feeding the bus tab into contact with the first end portion of the terminal via a slot extending from the GDE to the window.

In some implementations, positioning the GDE on the frame may include bonding the GDE to the frame. For example, bonding the GDE to the frame may include forming a seal between the GDE and the frame. Forming the seal between the GDE and the frame may include film adhesion, liquid adhesion, heat sealing, ultrasonic welding, or a combination thereof.

In certain implementations, connecting the bus tab and the first end portion of the terminal to one another through the window may include welding the bus tab and the first end portion of the terminal to one another through the window. Welding the bus tab and the first end portion of the terminal to one another may include resistance welding, laser welding, ultrasonic welding, or a combination thereof.

In some implementations, connecting the bus tab and the first end portion of the terminal to one another may include soldering, applying a conductive adhesive, crimping, or a combination thereof.

In certain implementations, the bus tab and the first end portion of the terminal may be connected one another via a fastener. The fastener may be any one or more of a rivet or a bolt.

In some implementations, hermetically sealing the window may include securing at least one cap to the frame with the at least one cap covering the window. The window may be a through-hole, and hermetically sealing the window includes securing a respective cap to the frame over each side of the through-hole. Further, or instead, securing the at least one cap to the frame may include laser welding, hot plate welding, impulse welding, gluing, potting, or a combination thereof.

According to another aspect, a discharge cathode assembly of a discharge cathode assembly may include: a frame of an electrically insulating material, the frame defining a slot; a terminal having a first end portion and a second end portion, the first end portion disposed in the frame and the second end portion extending outside of the frame; a gas diffusion electrode (GDE) bonded to the frame; a busbar supported on the gas diffusion electrode; and a bus tab extending from the busbar to the first end portion of the terminal via the slot, and the bus tab connected to the first end portion of the terminal.

In certain implementations, the frame may be plastic.

In some implementations, wherein the GDE and the frame may be bonded to one another with a hermetic tight seal therebetween.

In certain implementations the bus tab and the first end portion of the terminal may be welded to one another.

In some implementations, the bus tab and the first end portion of the terminal may be soldered to one another.

In certain implementations, the bus tab and the first end portion of the terminal may be fastened to one another.

In some implementations, the discharge cathode assembly may further include at least one cap hermetically sealed to the frame covering connection of the bus tab to the first end portion of the terminal.

According to still another aspect, a method of controlling airflow through a metal-air battery may include: directing airflow in a first direction over a gas diffusion electrode (GDE) of an electrochemical cell; receiving a signal indicative of an operational parameter associated with the electrochemical cell; comparing the signal to a predetermined threshold; and based on comparison of the signal to the predetermined threshold, reversing ai flow from the first direction to a second direction through the GDE.

In certain implementations, the GDE may be sealed in a frame defining a first air passage and a second air passage, and directing airflow in the first direction over the GDE includes moving air over the GDE generally from the first air passage to the second air passage. For example, reversing airflow from the first direction to the second direction may include moving air over the GDE generally from the second air passage to the first air passage.

In some implementations, reversing airflow from the first direction to the second direction may include reversing rotational direction of a blower.

In certain implementations, directing airflow in the first direction may include actuating a first blower, and reversing airflow from the first direction to the second direction includes toggling between activation of the first blower and a second blower.

In some implementations, reversing airflow from the first direction to the second direction may include actuating a first valve to restrict airflow in the first direction into the first air passage. For example, the first valve may be an active valve. As another example, the first valve may be a passive valve. In some instances, reversing airflow from the first direction to the second direction may include actuating a second valve to permit airflow in the second direction into the second air passage. The second valve may be an active valve or a passive valve.

In certain implementations, the operational parameter associated with the electrochemical cell may be operating time.

### DESCRIPTION OF THE DRAWINGS

FIG. 1 is a system block diagram of a power generation system according to various embodiments.

FIG. 2 is a system block diagram of a power generation system according to various embodiments.

FIG. 3 is a schematic representation of components of an electrochemical cell.

FIG. 4A is a perspective view of an outer portion of an electrochemical cell.

FIG. 4B is an exploded diagram of internal portions of the electrochemical cell of FIG. 4A.

FIG. 4C is a schematic representation of the arrangement of electrodes of the electrochemical cell shown in FIG. 4A.

FIG. 4D is a schematic representation of an arrangement of electrodes of an electrochemical cell, the arrangement of electrodes including a respective anode assembly between a respective oxygen evolution electrode (OEE) on either side of a gas diffusion electrode.

FIG. 5A is a schematic representation a module including a plurality of instances of electrochemical cells, with the schematic representation shown from an overhead view looking down the height (z dimension) of the plurality of instances of the electrochemical cells, and the plurality of electrochemical cells arranged in multiple rows from front to back of the module and with depth dimensions of each of the plurality of electrodes parallel with the side-to-side dimension of the module such that the plurality of electrochemical cells form a square footprint within the module.

FIG. 5B is a schematic representation of a module including a plurality of instances of electrochemical cells, with the schematic representation shown from an overhead view looking down the height (z dimension) of the plurality of instances of the electrochemical cells, and the plurality of electrochemical cells arranged in multiple rows from side-to-side of the module and with depth dimensions of each of the plurality of electrodes perpendicular to the side-to-side dimension of the module such that the plurality of electrochemical cells form a rectangular footprint within the module.

FIG. 5C is a schematic representation of a module including a plurality of instances of the electrochemical cells, with the schematic representation shown from an overhead view looking down the height (z dimension) of the plurality of instances of the electrochemical cells, the plurality of electrochemical cells arranged as a single row and with depth dimensions of the plurality of electrochemical cells perpendicular to the side-to-side dimension of the module such that the plurality of electrochemical cells form a rectangular footprint within the module.

FIG. 5D is a schematic representation of a module including a plurality of instances of the electrochemical cells, with the schematic representation shown from an overhead view looking down the height (z dimension) of the plurality of instances of the electrochemical cells, the plurality of electrochemical cells arranged as multiple rows from side-to-side with depth dimensions of each of the plurality of electrodes perpendicular to the side-to-side dimension of the module such that the plurality of electrochemical cells form a square footprint of the module.

FIG. 6A is a front view of a portion of an air electrode of the electrochemical cell of FIG. 4A.

FIG. 6B is a close-up, perspective view of a portion of the air electrode along the area of detail 6B in FIG. 6A.

FIGS. 7A-7B are a schematic representations of exemplary processes for pressing an airflow field in place during seal lamination of an electrode.

FIG. 8 is a schematic representation of an exemplary method for inserting a flow field into a pre-formed bifacial sealed electrode to form an electrode.

FIG. 9A is a schematic representation of a low pressure, high uniformity flow field using porous media for an electrode of an electrochemical cell.

FIG. 9B shows simulation results of a flow field along a long, narrow active area of an electrode, with the flow field formed using two symmetrical opposing strips of filter felt with a tapered geometry to balance pressure drop across the inlet to the outlet of the electrode.

FIG. 9C is a schematic representation of a flow field along a long, narrow active area of an electrode, with the flow field formed using a vertical feed and laterally positioned porous media strips to control and distribute airflow.

FIG. 9D shows simulation results of a flow field along a long, narrow active area of an electrode, with the flow field formed using horizontal serpentine channels of varying heights.

FIG. 9E shows simulation results of a flow field along a long, narrow active area of an electrode, with the flow field formed using vertical serpentine channels fed by a vertical inlet extending from a top of the flow field to a bottom of the flow field.

FIG. 9F is a schematic representation a long, narrow active area of an electrode including accordion folds of increasing height from top to bottom to form a flow field.

FIG. 9G is a schematic representation of a long, narrow active area of an electrode including a ladder structure of increasing spacing from top to bottom of the electrode.

FIG. 10A is a perspective view of a portion of a discharge cathode assembly including a frame, a gas discharge electrode (GDE), and a terminal, with an electrical connection path from the terminal to the GDE shown schematically as a dashed line.

FIG. 10B is a perspective view of the discharge cathode assembly of FIG. 10A, shown with the GDE removed.

FIG. 10C is a front view of the portion of the discharge cathode assembly shown in FIG. 10B.

FIG. 10D is a close-up, front view of the area of detail 10D in FIG. 10C.

FIG. 10E is a close-up, perspective wive of the area of detail 10E in FIG. 10D.

FIG. 10F is a perspective view of the cross-section 10F-10F of FIG. 10E.

FIGS. 11A-11E collectively represent a process for connecting a segment of a busbar to an electrode and feeding the segment through a frame to form the discharge cathode assembly of FIG. 10A.

FIGS. 12A-12F collectively represent an alternative process for connecting a segment of a busbar to an electrode and feeding the segment through a frame to form the discharge cathode assembly of FIG. 10A.

FIG. 13 is a partial perspective view of a process of bonding a gas diffusion electrode to a frame to form the discharge cathode assembly of FIG. 10A.

FIG. 14 is a partial perspective view of a frame showing sealing of a window of the frame to form the discharge cathode assembly of FIG. 10A.

FIG. 15 is a flow chart of an exemplary method for fabricating a discharge cathode assembly of a metal-air battery.

FIG. 16A is a schematic representation of a discharge cathode assembly showing airflow in a first direction from a first air passage to a second air passage via a gas diffusion electrode.

FIG. 16B is a schematic representation of the discharge cathode assembly of FIG. 16A showing airflow in a second direction from the first air passage to the second air passage via the gas diffusion electrode.

FIG. 17 is a partially exploded, perspective view of a portion of a module of electrochemical cells, the module including a discharge cathode assembly including a plurality of gas diffusion electrodes, a first air passage defined by a first manifold, and a second air passage defined by a second manifold.

FIG. 18 is a cross-sectional view of the first manifold of the discharge cathode assembly of FIG. 17, the cross-section taken along 18-18 in FIG. 17.

FIG. 19 is a flowchart of an exemplary method for controlling airflow through a discharge cathode assembly.

Like reference symbols in the various drawings indicate like elements.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments is not intended to be limiting and, instead, is intended to enable a person skilled in the art to make and use these embodiments or combinations thereof.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the disclosure provided herein. Thus, the scope of the present disclosure should not be limited to a particular embodiment, configuration or arrangement that is set forth in a particular embodiment, example, or in an embodiment in a particular figure.

Embodiments of the present disclosure may include systems, methods, and devices for electrochemical energy storage systems, such as metal-air battery systems. Systems and methods of the various embodiments may provide for construction and configuration of electrodes and/or cell components of metal-air battery systems.

Various embodiments may provide devices and/or methods for use in long-duration, and ultra-long-duration, low-cost, energy storage, including in multi-day energy storage. Herein, “long duration” and “ultra-long duration” and similar such terms, unless expressly stated otherwise, should be given their broadest possible meaning and include periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. and would include long duration energy storage (LODES) systems. Further, the terms “long duration” and “ultra-long duration”, “energy storage cells” including “electrochemical cells”, and similar such terms, unless expressly stated otherwise, should be given their broadest possible interpretation; and include electrochemical cells that may be configured to store energy over time spans of days, weeks, or seasons, such as electrochemical cells sometimes referred to as multi-day energy storage (MDS) cells. As a matter of definition, the term “duration” means the ratio of energy to power of an energy storage system. For example, a system with a rated energy of 24 MWh and a rated power of 8 MW has a duration of 3 hours; a system with a rated energy of 24 MWh and a rated power of 1 MW has a duration of 24 hours. Physically, this may be interpreted as the run-time at maximum power for the energy storage system.

In general, in an embodiment, the long duration energy storage cell can be a long duration electrochemical cell. In general, this long duration electrochemical cell can store electricity generated from an electrical generation system, when: (i) the power source or fuel for that generation is available, abundant, inexpensive, and combinations and variations of these; (ii) when the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. This electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

Various embodiments may provide devices and/or methods for use in bulk energy storage systems, such as long duration energy storage (LODES) systems (e.g., multi-day energy storage (MDS) systems), short duration energy storage (SDES) systems, etc. As an example, various embodiments may provide configurations and controls for batteries of bulk energy storage systems, such as batteries for LODES systems.

While various examples are discussed with reference to Li-ion and/or Fe-air, the discussion of Li-ion and/or Fe-air is used merely as an example and various embodiments encompass other combinations and permutations of storage technologies that may be substituted for the example solar+Li-ion+Fe-air discussions herein. For example, various metal-air storage technologies may be used as batteries in the various embodiments, such as Zinc-air, lithium-air, sodium-air, etc.

As used herein, the term “module” may refer to a string of unit electrochemical cells (e.g., a string of batteries). Multiple modules (or multiple units or electrochemical cells) may be connected together to form battery strings.

Unless otherwise expressed or made clear from the context, the recitation of any element in the singular shall be understood to be intended to encompass embodiments including one or more of such elements and the separate recitation of “one or more” is generally omitted for the sake of clarity and readability. Thus, for example, recitation of a LODES system 104 shall be understood to be inclusive of one or more LODES systems, etc.

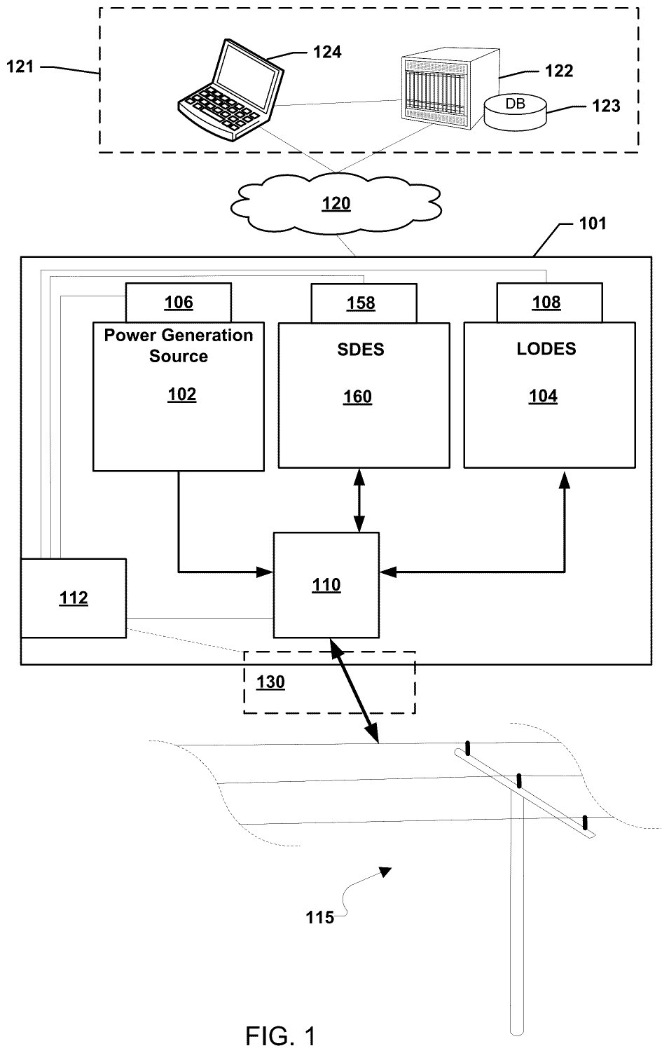

FIG. 1 is a system block diagram of a power generation system 101 according to various embodiments. The power generation system 101 may be a power plant including a power generation source 102, a LODES systems 104 (e.g., a multi-day energy storage (MDS) system), and an SDES systems 160. As examples, the power generation source 102 may include renewable power generation sources, non-renewable power generation sources, combinations of renewable and non-renewable power generation sources, etc. Examples of the power generation sources 102 include wind generators, solar generators, geothermal generators, nuclear generators, etc. The LODES system 104 may include an electrochemical cell (e.g., one or more batteries). The batteries of the LODES systems 104 may be any type of battery, such as rechargeable secondary batteries, refuellable primary batteries, combinations of primary and secondary batteries, etc. Battery chemistries may be any suitable chemistry, such as Al, AlCl₃, Fe, FeOₓ(OH)_{y}, NaₓS_{y}, SiOₓ(OH)_{y}, AlOₓ(OH)_{y}, metal-air, and/or any suitable type of battery chemistry. The SDES systems 160 may include one or more electrochemical cells (e.g., one or more batteries). The batteries of the SDES systems 160 may be any type of battery, such as rechargeable secondary batteries, refuellable primary batteries, combinations of primary and secondary batteries, etc. Battery chemistries may be any suitable chemistry, such as Li-ion, Na-ion, NiMH, Mg-ion, and/or any suitable type of battery chemistry.

In various embodiments, the operation of the power generation source 102 may be controlled by a first control system 106. The first control system 106 may include motors, pumps, fans, switches, relays, or any other type of devices that may control the generation of electricity by the power generation source 102. In various embodiments, the operation of the LODES system 104 may be controlled by a second control system 108. The second control system 108 may include motors, pumps, fans, switches, relays, or any other type of devices that may control the discharge and/or storage of electricity by the LODES system. In various embodiments, the operation of the SDES system 160 may be controlled by a third control system 158. The third control system 158 may include motors, pumps, fans, switches, relays, or any other type of devices that may control the discharge and/or storage of electricity by the SDES system 160. The first control system 106, the second control system 108, and the third control system 158 may each be connected to a plant controller 112. The plant controller 112 may monitor the overall operation of the power generation system 101 and generate and send control signals to the first control system 106, the second control system 108, and the third control system 158 to control the operations of the power generation source 102, the LODES system 104, and/or the SDES system 160.

In the power generation system 101, the power generation source 102, the LODES system 104, and the SDES system 160 may each be connected to a power control device 110. The power control device 110 may be connected to a power grid 115 or other transmission infrastructure. The power control device 110 may include switches, inverters (e.g., AC to DC inverters, DC to AC inverters, etc.), relays, power electronics, and any other type of devices that may control the flow of electricity from to/from the power generation source 102, the LODES system 104, the SDES system 160, and/or the power grid 115. Additionally, or alternatively, the power generation system 101 may include transmission facilities 130 connecting the power generation, transmission, and the power generation system 101 to the power grid 115. As an example, the transmission facilities 130 may connect between the power control device 110 and the power grid 115 such that electricity may flow between the power generation system 101 and the power grid 115. Transmission facilities 130 may include transmission lines, distribution lines, power cables, switches, relays, transformers, and any other type of devices that may support the flow of electricity between the power generation system 101 and the power grid 115. The power control device 110 and/or the transmission facilities 130 may be connected to the plant controller 112. The plant controller 112 may monitor and control the operations of the power control device 110 and/or the transmission facilities 130, such as via various control signals. As examples, the plant controller 112 may control the power control device 110 and/or the transmission facilities 130 to provide electricity from the power generation source 102 to the power grid 115, to provide electricity from the LODES system 104 to the power grid 115, to provide electricity from both the power generation source 102 and the LODES system 104 to the power grid 115, to provide electricity from the power generation source 102 to the LODES system 104, to provide electricity from the power grid 115 to the LODES system 104, to provide electricity from the SDES system 160 to the power grid 115, to provide electricity from both the power generation source 102 and the SDES system 160 to the power grid 115, to provide electricity from the power generation source 102 to the SDES system 160, to provide electricity from the power grid 115 to the SDES system 160, to provide electricity from the SDES system 160 and the LODES system 104 to the power grid 115, and/or to provide electricity from the power generation source 102, the SDES system 160, and the LODES system 104 to the power grid 115. In various embodiments, the power generation source 102 may selectively charge the LODES system 104 and/or SDES system 160 and the LODES system 104 and/or SDES system 160 may selectively discharge to the power grid 115. In this manner, energy (e.g., renewable energy, non-renewable energy, etc.) generated by the power generation source 102 may be output to the power grid 115 sometime after generation from the LODES system 104 and/or the SDES system 160.

In various embodiments, the plant controller 112 may be in communication with a network 120 (e.g., 3G network, 4G network, 5G network, core network, Internet, combinations of the same, etc.). Using the connections to the network 120, the plant controller 112 may exchange data with the network 120 as well as with devices connected to the network 120, such as a plant management system 121 or any other device connected to the network 120. The plant management system 121 may include one or more computing devices, such as a computing device 124 and a server 122. The computing device 124 and the server 122 may be connected to one another directly and/or via connections to the network 120. The various connections to the network 120 by the plant controller 112 and devices of the plant management system 121 may be wired and/or wireless connections.

In various embodiments, the computing device 124 of the plant management system 121 may provide a user interface that facilitates providing user-defined inputs to the plant management system 121 and/or to the power generation system 101, receiving indications associated with the plant management system 121 and/or with the power generation system 101, and/or otherwise controlling operation of the plant management system 121 and/or the power generation system 101.

While shown as two separate devices, 124 and 122, the functionality of the computing device 124 and server 122 described herein may be combined into a single computing device or may split among more than two devices. Additionally, or alternatively, while shown as part of the plant management system 121, the functionality of one or both the computing device 124 and the server 122 may be entirely, or partially, carried out by a remote computing device, such as a cloud-based computing system. Further, or instead, while shown as being in communication with a single instance of the power generation system 101, the plant management system 121 may be in communication with multiple instances of the power generation system 101.

While shown as being located together in FIG. 1, the power generation source 102, the LODES system 104, and the SDES system 160 may be physically separated from one another in various implementations. For example, the LODES system 104 may be downstream of a transmission constraint, such as downstream of a portion of the power grid 115, downstream from the power generation source 102 and SDES system 160, etc. In this manner, the overbuild of underutilized transmission infrastructure may be reduced, or even avoided, by situating the LODES system 104 downstream of a transmission constraint, charging the LODES system 104 at times of available capacity and discharging the LODES system 104 at times of transmission shortage. The LODES system 104 may also, or instead, arbitrate electricity according to prevailing market prices to reduce the final cost of electricity to consumers.

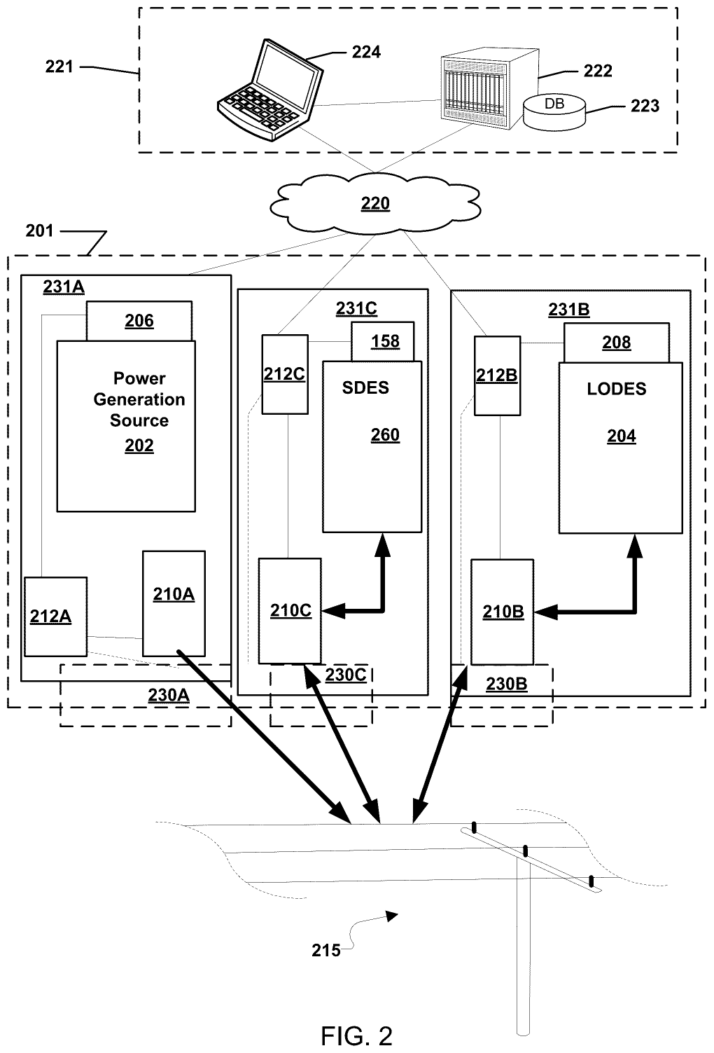

FIG. 2 is a system block diagram of a power generation system 201 in which various elements of the power generation system 201 may be physically separated from one another according to various embodiments. For the sake of clear and efficient description, elements in FIG. 2 with numbers having the same last two digits as in FIG. 1 shall be understood to be analogous to or interchangeable with one another, unless otherwise specified or made clear from the context, and, therefore, are not described separately from one another, except to note differences and/or to emphasize certain features. For example, the power generation system 101 (FIG. 1) shall be understood to be analogous to and/or interchangeable with the power generation system 201, unless a contrary intent is expressed or made clear from the context.

As an example, the power generation system 201 may include a power generation source 202 and one or more bulk energy storage systems, such as a LODES system 204 and/or an SDES system 260. The power generation source 202, the LODES system 204, and/or the SDES system 160 may be separated in the power plants 231A, 231B, 231C, respectively. While the power plants 231A, 231B, 231C may be separated from one another, the power generation system 201 and a plant management system 121 may operate as described above with reference to operation of the power generation system 101 and the plant management system 121 (FIG. 1). While the power plants 231A, 231B, and 231C may be co-located or may be geographically separated from one another. The power plants 231A, 231B, and 231C may connect to the power grid 215 at different places. For example, the power plant 231A may be connected to the power grid 215 upstream of where the power plant 231B is connected.

In some implementations, the power plant 231A associated with the power generation source 202 may include dedicated equipment for the control of the power plant 231A and/or for transition of electricity to/from the power plant 231A. For example, the power plant 231A may include a plant controller 212A and a power controller 110A and/or a transmission facility 230A. The power controller 210A and/or the transmission facility 230 may be connected in electrical communication with the plant controller 112A. The plant controller 212A may, for example, monitor and control the operations of the power controller 210A and/or the transmission facility 230A, such as via various control signals. As examples, the plant controller 212A may control the power controller 210A and/or transmission facility 230A to provide electricity from the power generation sources 202 to the power grid 215, etc.

Additionally, or alternatively, the power plant 231B associated with the LODES system 204 may include dedicated equipment for the control of the power plant 231B and/or for transmission of electricity to/from the power plant 231B. For example, the power plant 231B associated with the LODES system 204 may include a plant controller 112B, a power controller 210B, and/or a transmission facility 230B. The power controller 210B and/or the transmission facility 230B may be connected to the plant controller 212B. The plant controller 212B may monitor and control the operations of the power controller 210B and/or of the transmission facility 230B, such as via various control signals. As an example, the plant controller 212B may control the power controller 210B and/or the transmission facility 230B to provide electricity from the LODES system 204 to the power grid 215 and/or to provide electricity from the power grid 215 to the LODES system 204, etc.

Still further, or instead, the power plant 231C associated with the SDES system 260 may include dedicated equipment for the control of the power plant 231C and/or for transmission of electricity to/from the power plant 231C. For example, the power plant 231C associated with the SDES system 260 may include a plant controller 212C and a power controller 210C and/or a transmission facility 230C. The power controller 210C and/or the transmission facility 230C may be connected to the plant controller 212C. The plant controller 212C may monitor and control the operations of the power controller 210C and/or transmission facility 230C, such as via various control signals. As examples, the plant controller 212C may monitor and control the operations of the power controller 210C and/or transmission facility 230C, such as via various control signals. As examples, the plant controller 212 may control the power controller 210C and/or the transmission facility 230C to provide electricity from the SDES system 260 to the power grid 215 and/or to provide electricity from the power grid 215 to the SDES system 260, etc.

In various embodiments, the plant controllers 212A, 212B, 212C may each be in communication with each other and/or with a network 220. Using the connections to the network 220, the plant controllers 212A, 212B, 212C may exchange data with the network 220 as well as with one or more devices connected to the network 220, such as a plant management system 221, each other, or any other device connected to the network 220. In various embodiments, the operation of the plant controllers 212A, 212B, 212C may be monitored by the plant management system 221 and the operation of the plant controllers 212A, 212B, 212C—and, thus, operation of the power generation system 201, may be controlled by the plant management system 221.

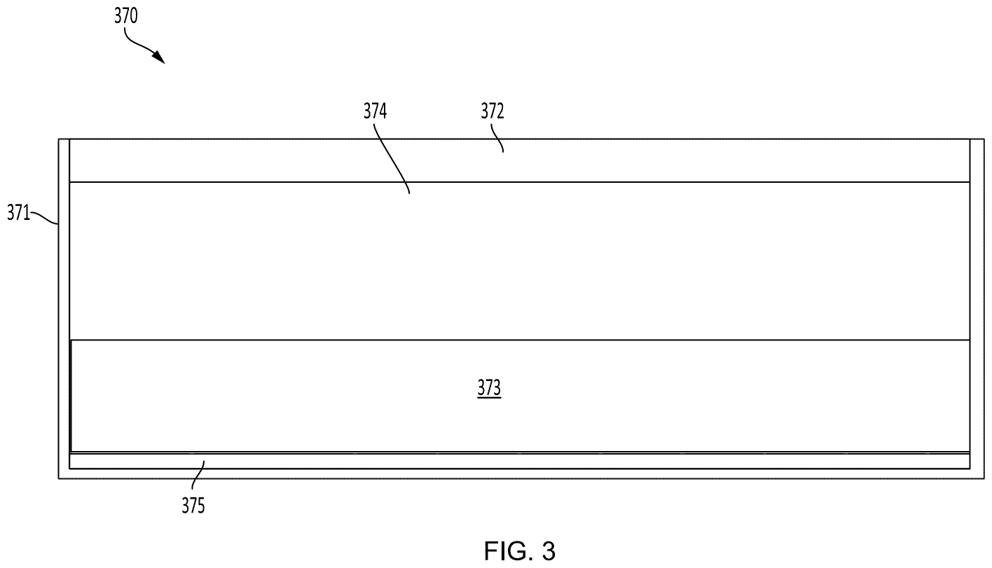

FIG. 3 is a schematic view of a battery 370 that may be used in the one or more LODES systems described herein (e.g., the LODES system 204 in FIG. 1 and/or the LODES system 204 in FIG. 2). The battery 370 may include a vessel 371, a gas diffusion electrode (GDE) 372, an anode 373, an electrolyte 374, and a current collector 375. The GDE 372, the anode 373, the electrolyte 374, and the current collector 375 may each be disposed in the vessel 371. The anode 373 may include a metal electrode (e.g., an iron electrode, a lithium electrode, a zinc electrode, or other type of suitable metal). The electrolyte 374 may separate the GDE 372 from the anode 373. Additionally, specific examples of batteries, such as batteries similar to battery 370, that may be used in bulk energy storage systems, such as in LODES systems of the present disclosure are described in U.S. Pat. App. Pub. 2021/0028457, the entire contents of which are incorporated herein by reference. As examples, the battery 370 may be a metal-air type battery, such as an iron-air battery, a lithium-air battery, a zinc-air battery, etc. While various examples are discussed with reference to metal-air batteries, other type batteries may be additionally, or alternatively, used in the various examples provided herein unless otherwise specified or made clear from the context. The battery 370 may be a single cell or unit, and multiple instances of the battery 370—namely, multiple units or cells—may be connected together to form a module. Multiple modules may be connected to one another to form a battery string.

In various embodiments, the anode 373 may be solid and the electrolyte may be excluded from the anode. In various embodiments the anode 373 may be porous and the electrolyte 374 may be interspersed geometrically with the anode 373, creating a greater interfacial surface area for reaction. Further, or instead, the air electrode 203 may be porous and the electrolyte 374 may be interspersed geometrically with the anode 373, creating a greater interfacial surface area for reaction. Still further, or instead, the GDE 372 may be at an interface of the electrolyte 374 and a gaseous headspace (not shown in FIG. 3). The gaseous headspace may, for example, be sealed in a housing. Additionally, or alternatively, the housing may be unsealed and the gaseous headspace may be an open system which can freely exchange mass with the environment.

The anode 373 may be formed from a metal or metal alloy, such as lithium (Li), sodium (Na), potassium (K), magnesium (Mg), calcium (Ca), silicon (Si), aluminum (Al), zinc (Zn), or iron (Fe); or alloys substantially comprised of one or more of the forgoing metallic elements, such as an aluminum alloy or iron alloy (e.g., FeAl, FeZn, FeMg, etc.) that can undergo an oxidation reaction for discharge. As such, the anode 373 may be referred to as a metal electrode herein.

In certain embodiments, the battery 370 may be rechargeable and the anode 373 may undergo a reduction reaction when the battery 370 is charged. The anode 373 may be a solid, including a dense or porous solid, or a mesh or foam, or a particle or collection of particles, or may be a slurry, ink, suspension, or paste deposited within the housing. In various embodiments, composition of the anode 373 may be selected such that the anode 373 and the electrolyte 374 do not mix together to any substantial extent, allowing for only small amounts of solubility that do not impact performance of the battery 370. For example, the anode 373 may be a metal electrode that may be a bulk solid. Further, or instead, the anode 373 may include a collection of particles, such as small or bulky particles, within a suspension, and the collection of particles may not be buoyant enough to escape the suspension into the electrolyte 374. Additionally, or alternatively, the anode 373 may include particles that are not buoyant in the electrolyte 374.

The GDE 372 may support the reaction with oxygen. As an example, the GDE 372 may be a solid and may sit at the interface of a gas headspace and the electrolyte 374. During the discharge process, the GDE 372 may support the reduction of oxygen from the gaseous headspace, in a reaction known as the Oxygen Reduction Reaction (ORR). In certain embodiments, the battery 370 may be rechargeable and the reverse reaction may occur—namely, the reaction in which the GDE supports the evolution of oxygen from the battery, in a reaction known as Oxygen Evolution Reaction (OER). The OER and ORR reactions are commonly known to those skilled in the art.

In various embodiments, the electrolyte 374 may be a liquid electrolyte. For example, the electrolyte 374 may be an aqueous solution, a non-aqueous solution, or a combination thereof. In various embodiments, the electrolyte 374 may be an aqueous solution which may be acidic (low-pH), neutral (intermediate pH), or basic (high pH; also called alkaline or caustic). In certain embodiments, the electrolyte 374 may comprise an electropositive element, such as Li, K, Na, or combinations thereof. In some embodiments, the liquid electrolyte may be basic, namely with a pH greater than 7. In some embodiments the pH of the electrolyte may be greater than 10 (e.g., greater than 12). For example, the electrolyte 374 may include a 6 M (mol/liter) concentration of potassium hydroxide (KOH). In certain embodiments, the electrolyte 374 may include a combination of ingredients such as 5.5 M potassium hydroxide (KOH) and 0.5 M lithium hydroxide (LiOH). In certain embodiments, the electrolyte 374 may comprise a 6 M (mol/liter) concentration of sodium hydroxide (NaOH). In certain embodiments, the electrolyte 374 may comprise a 5 M (mol/liter) concentration of sodium hydroxide (NaOH) and 1 M potassium hydroxide (KOH).

In certain embodiments, the battery 370 (e.g., metal-air battery) may discharge by reducing oxygen (O₂) typically sourced from air. This may achieved by a triple-phase contact between gaseous oxygen, an electronically active conductor which supplies the electrons for the reduction reaction, and the electrolyte 374 which contains the product of the reduction step. For example, in certain embodiments involving an aqueous alkaline electrolyte, oxygen from air may be reduced to form hydroxide ions through the half-reaction O₂+2H₂O+4e⁻→4OH⁻. Thus, oxygen delivery to metal-air cells may include gas handling and maintenance of triple-phase points. In certain embodiments, sometimes referred to as “normal air-breathing” configurations, the GDE 372 may be positioned at the gas-liquid interface to promote and maintain triple-phase boundaries. The GDE 372 may be positioned vertically or horizontally, or at any intermediate angle with respect to gravity, and maintain a “normal air-breathing” configuration. In these “normal air-breathing” configurations, the gas phase is at atmospheric pressure—that is, gas phase is unpressurized beyond the action of gravity.

The battery 370 in FIG. 3 is merely an example of one electrochemical cell according to various embodiments and is not intended to be limiting. Other configurations, such as electrochemical cells with different types of vessels and/or without the vessel 371, electrochemical cells with different types of air electrodes and/or without the GDE 372, electrochemical cells with different types of current collectors and/or without the current collector 375, electrochemical cells with different types of anodes and/or without the anode 373, and/or electrochemical cells with different types of electrolytes and/or electrochemical cells without the electrolyte 374 may be substituted for the example configuration of the battery 370, and other arrangements are in accordance with the various embodiments.

In various embodiments, the vessel 371 may be made from a polymer such as polyethylene, acrylonitrile butadiene styrene (ABS), high-density polyethylene (HDPE), ultra-high molecular weight polyethylene (UHMW), polypropylene, and/or other polymers. In certain embodiments, the vessel 371 and/or housing for the battery 370 may be made from a metal such as nickel, steel, anodized aluminum, nickel coated steel, nickel coated aluminum or other metal.

In various embodiments, a battery (e.g., the battery 370) may include three electrodes—an anode (e.g., the anode 373) and a dual cathode (e.g., GDE 372 including two parts, such as a first cathode, and a second cathode). The electrodes may have finite useful lifetimes, and may be mechanically replaceable. For example, the anode may be replaced seasonally. The first cathode of the dual cathode may be divided into two portions, a first portion having a hydrophilic surface and a second portion having a hydrophobic surface. For example, the hydrophobic surface may have a polytetrafluorethylene (PTFE) (e.g., Teflon®) hydrophobic surface.

For example, the second portion having the hydrophobic surface may include a microporous layer of polytetrafluorethylene (PTFE) and high surface area carbon while the first portion having the hydrophilic surface may include carbon fiber partially coated with PTFE. As another example, the second portion may include a microporous layer of PTFE and carbon black and the first portion may include PTFE of approximately 33% by weight. As a further example, the second portion may include a microporous layer of 23% by weight PTFE and 77% by weight carbon black and the first portion may include a low loading microporous layer. The anode may be an iron (Fe) electrode or an iron-alloy (Fe-alloy) electrode (e.g., FeAl, FeZn, FeMg, etc.). The second cathode of the dual cathode may include a hydrophilic surface. The second cathode of the dual cathode may include a metal substrate, such as carbon (C), titanium (Ti), steel, etc., coated with nickel (Ni). Electrolyte (e.g., electrolyte 140) may be disposed between the three electrodes. The electrolyte may be infiltrated into one or more of the three electrodes.

Battery systems may include a number of cells connected in series and/or parallel in a shared electrolyte bath and contained in a housing.

Referring now to FIGS. 1-4C, FIG. 4A an electrochemical cell 400 may include at least one battery, such as at least one instance of the battery 200, in accordance with various embodiments. In some implementations, the electrochemical cell 400 may include a vessel 401 (e.g., such as the vessel 371), in which an air electrode (e.g., a cathode), such as the GDE 372, a negative electrode (e.g., an anode), such as the anode 373, and an electrolyte, such as the electrolyte 374, are disposed. The electrolyte, such as the electrolyte 374, may rise to a given level within the vessel 401 and a headspace between the top of the vessel 401 and electrolyte level may be formed in the electrochemical cell 400. The vessel 401 may have a height (e.g., a z dimension), a width (e.g., a y dimension), and a depth (e.g., a x dimension). In one example configuration, the height may be greater than the width and depth and the width may be greater than the depth such that the vessel 401 is a generally rectangular cuboid. The vessel 401 may include one or more various connections, such as electrical connections, electrolyte connections, gas connections (e.g., air connections), vents, etc. Via the connections, two or more electrochemical cells (e.g., two or more instances of the electrochemical cell 400) may be connected together, such as in series and/or in parallel, to form a module.

In a module formed of a plurality of instances of the electrochemical cell 400, each instance of the electrochemical cell 400 may be a self-contained unit supporting its own respective air electrode (e.g., the GDE 372), anode electrode (e.g., the anode 373), and electrolyte (e.g., the electrolyte 374). The module structure may support the vessel 401 of the electrochemical cells 400 disposed within the given module.

The vessel 401 may have disposed within it one or more instances of an anode assembly 402a,b (e.g., one or more instances of the anode 373), one or more instances of a cathode (e.g., the air electrode 203), and an electrolyte (e.g., the electrolyte 374). As an example, each instance of the cathode assembly may include a respective instance of an Oxygen Evolution Electrode (OEE) 403a,b and a gas diffusion electrode (GDE) 404. A battery including at least one instance of the OEE 403 and at least one instance of the GDE 404 may be referred to as a multi-cathode battery cell.

A first OEE 403a may be disposed within the vessel 401, between a first anode assembly 402a and the GDE 404. On the opposite side of the GDE 404, a second OEE 403b and a second anode assembly 402b may be in a mirror configuration relative to the GDE 404. That is, within the vessel 401, the GDE 404 may be disposed between symmetric arrangements of: 1) the first anode assembly 402a and the first OEE 403a; and 2) the second anode assembly 402b and the second OEE 403b. As a specific example, the GDE 404 may be disposed centrally within a volume defined by the vessel 401, such that the length and width of the GDE 404 is at least partially disposed along a center plane defined by the length and width of the volume defined by the vessel 401 and intersecting a midpoint of the depth dimension of the volume defined by the vessel 401. Air may enter the volume of the vessel 401 and pass into the GDE 404 (e.g., into a center portion of the GDE 404) between the first OEE 403a and the second OEE 403b. The electrochemical cell 400 may include first standoff elements 451 between the first anode assembly 402a and the first OEE 403a and between the second anode assembly 402b and the second OEE 403b. Further, or instead, the electrochemical cell 400 may include second standoff elements 452 between the first OEE 403a and the GDE 404 and between the second OEE 403b and the GDE 404. However, such internal arrangement of the electrochemical cell 400 is merely one example configuration within the vessel 401, and is not intended to be limiting.

In some implementations, the electrochemical cell 400 may include an electronics structure 450, which may include a printed circuit board assembly (PCBA), circuitry housing, etc., as may be useful for supporting various electronic devices (e.g., controllers, sensors, switches, wiring buses, etc.) that may control and/or manage one or more operations of the electrochemical cell 400. The electrochemical cell 400 may additionally, or alternatively, include a lid 455 and an electrode holder 454 on opposite sides along a length dimension of the vessel 401. Straps 453 may secure the lid 455 and the electrode holder 454 to the vessel 401. The electronics structure 450 may be supported on the lid 455 in some configurations.

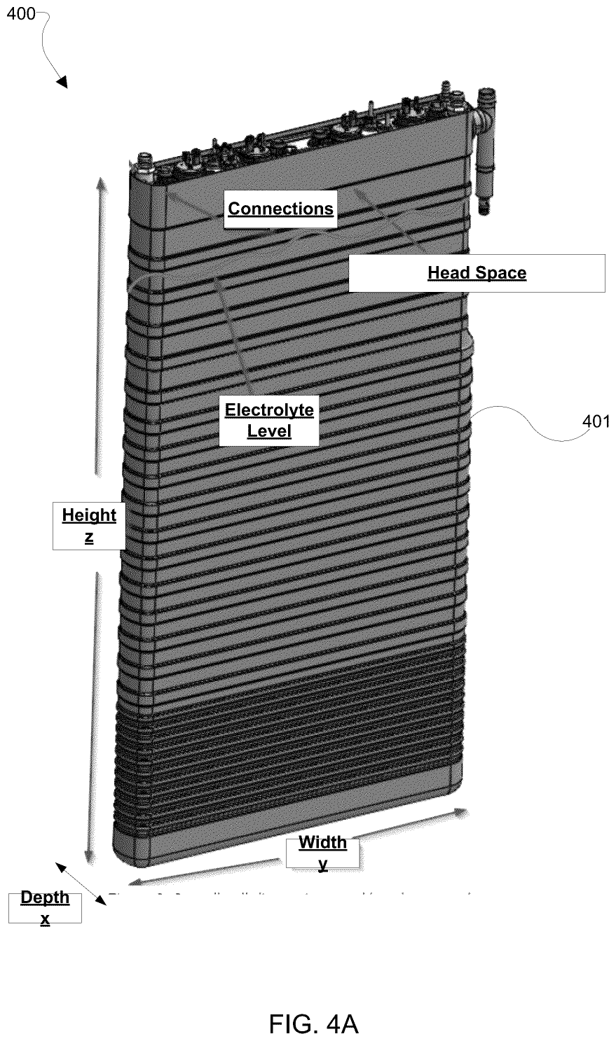

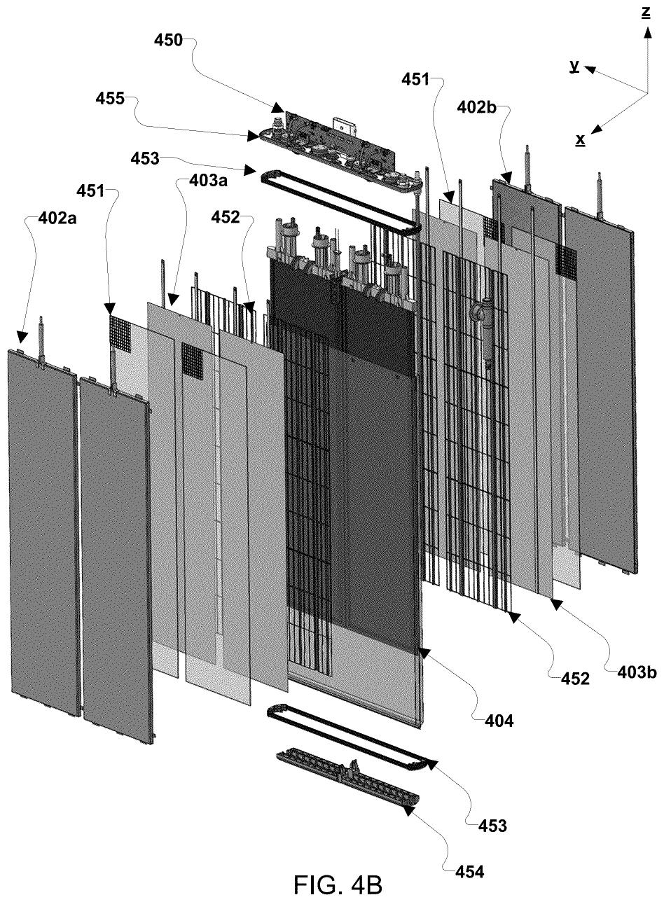

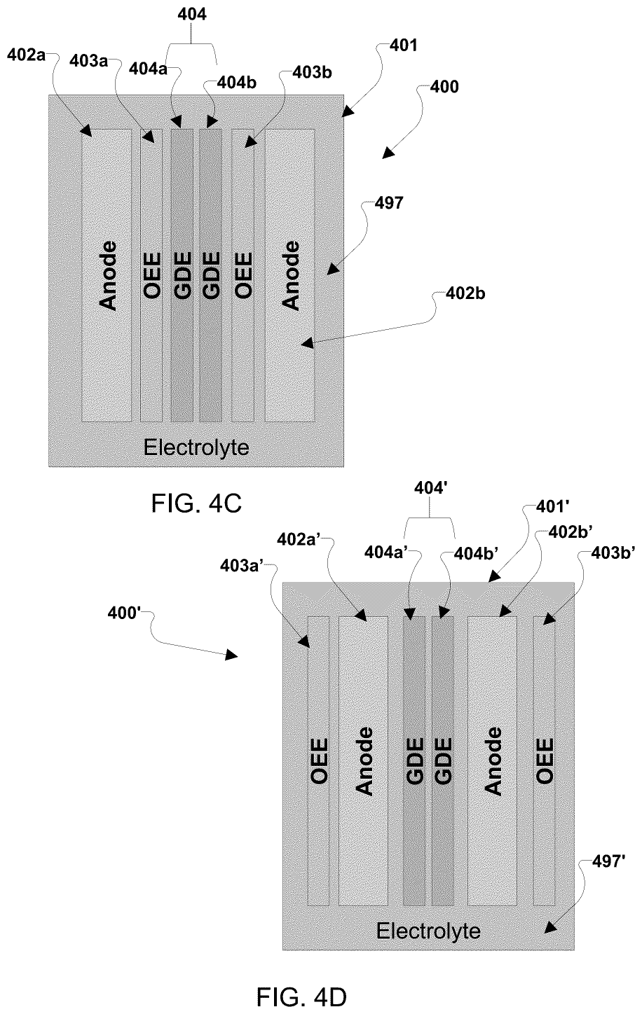

In general, the first OEE 403a, the first anode assembly 402a, the GDE 404, the second OEE 403b, and the second anode assembly 402b may each be disposed in an electrolyte 497 within the volume of the vessel 401 of the electrochemical cell 400. As discussed herein, the GDE 404 may include a two part electrode with two faces sealed on three-sides to form a two-faced pocket construction defining a central air passage between the two faces. As compared to other configurations, the amount of inactive material used in construction of the GDE 404 (e.g. flowfield, epoxy “trough” or frame) may be reduced by making a 2-sided GDE (air in the middle with active faces on either side). To facilitate construction of the GDE 404, the first anode assembly 402a and the first OEE 403a may be mirrored about the GDE 404 by the second anode assembly 402b and the second OEE 403b. Along the depth dimension of the vessel 401, in a direction from right to left in FIG. 4C, a construction of electrodes within the vessel 401 of the electrochemical cell 400 may be: the first anode assembly 402a|the first OEE 403a|a first portion 404a of the GDE 404|a second portion 404b of the GDE 404|the second OEE 403b|the second anode assembly 402b. For ease of manufacturing and assembly, each electrode may be further divided into two mechanically distinct electrodes across the width dimension of the vessel 401—thus resulting in the electrochemical cell having 4 anodes (e.g., two instances of the first anode assembly 402a and two instances of the second assembly 402b), 4 OEEs (e.g., two instances of the first OEE 403a and two instances of the second OEE 403b), and two instances of the GDE 404. Electrically and electrochemically, all electrodes may function as a parallel circuit (e.g. common potential among all anodes).

With reference to FIGS. 1-4C and 5A, a module 501 is shown from an overhead view looking down the height (e.g., z dimension) of a plurality of instances of the electrochemical cell 400. The module 501 may be a generally square configuration with the front, back, and sides of the module 501 about the same lengths. In the module 501, the plurality of instances of the electrochemical cell 400 may be arranged in two rows such that the respective width dimensions of the plurality of instances of the electrochemical cell are parallel to the sides of the module 501 and the respective depths of the vessel 401 run parallel to the front and back of the module 501. In the configuration of the module 501, the combined width of the two rows of the plurality of instances of the electrochemical cell 400, along with any spacing between the two rows and the front and the back of the module, may generally govern the length of each side of the module 501. The number of instances of the electrochemical cell 400 in each row and the depth dimension of each instance of the vessel 401, along with the spacing between the instances of the vessel 401 in each row and the spacing of the respective rows from the sides of the module 501, may generally govern the length from the front to the back of the module 501. As described in greater detail below, other arrangements of a plurality of instances of the electrochemical cell 400 are additionally, or alternatively, possible to form modules with other footprints.

While various aspects of electrochemical cells and modules of such electrochemical cells have been described, it shall be appreciated that other implementations are additionally or alternatively possible.

For example, while the electrochemical cell 400 has been described as including one type of mirrored arrangement of anode assemblies and OEEs relative to the GDE 404, it shall be appreciated that another type of mirrored arrangement is additionally or alternatively possible. For example, referring now to FIG. 4D, along a depth dimension of a vessel 401′ in a direction from left to right in FIG. 4D, a construction of electrodes within the vessel 401′ of an electrochemical cell 400′ may be: a first OEE 403a′ |a first anode assembly 402a′ |the first portion 404a′ of the GDE 404′ |the second portion 404b of the GDE 404′ |a second anode assembly 402b|and a second OEE 403b′. In this context, element numbers designated with a prime (′) shall be understood to be identical to corresponding element numbers that are unprimed, except to the extent necessary to accommodate the different positioning of electrodes in FIG. 4D relative to the positioning shown in FIGS. 4B and 4C. Further, or instead, the electrochemical cell 400′ shall be understood to be interchangeable with the electrochemical cell 400 in the description that follows. However, for the sake of clear and efficient description, the description, reference in the description that follows is made only to the electrochemical cell 400.

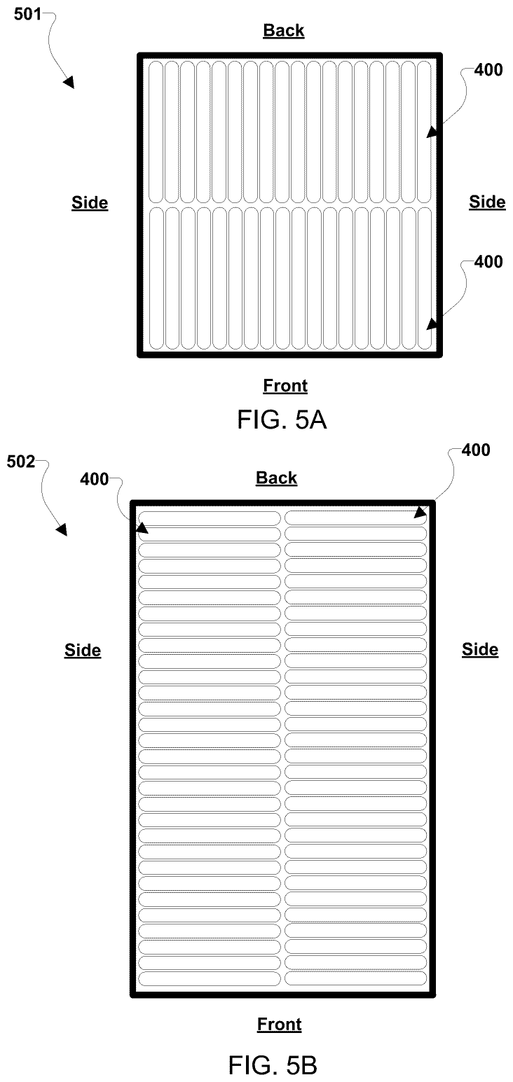

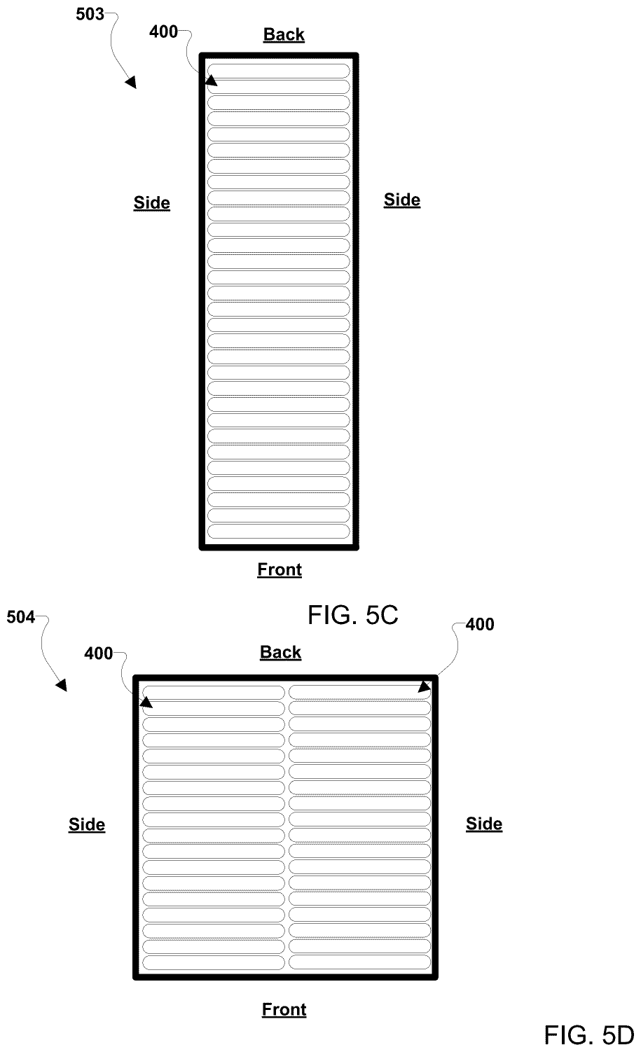

As another example, while the module 501 has been described as having a particular arrangement of electrochemical cells to form a particular footprint, it shall be appreciated that other arrangements of electrochemical cells are additionally or alternatively possible to form modules. As an example, referring now to FIG. 5B, a module 502 configuration may include multiple instances of the electrochemical cell 400 in accordance with various embodiments. The module 502 configuration may be a generally rectangular configuration with the sides of the module 502 longer than the back and front of the module 502. In the module 502, two rows of instances of the electrochemical cell 400 may be arranged such that the widths of the plurality of instances of the electrochemical cell 400 are parallel to the front and back of the module 502 and the depths of the plurality of instances of the electrochemical cell 400 are parallel to the sides of the module 502. In the configuration of the module 502, the widths of two instances of the electrochemical cell 400 may generally govern the length of the front and back of the module 502 along with any spacing between the rows of instances of the electrochemical cell 400 and spacing of the respective rows and the sides of the module 502. The number of instances of the electrochemical cell 400 in each row and the depth of the plurality of instances of the electrochemical cells 400 may generally govern the length of the sides of the module 502 along with the spacing between the plurality of instances of the electrochemical cells 400 in each row and the spacing of the respective rows and the front and back of the module 502.

As another example, referring now to FIG. 5C, a module 503 configuration may include multiple instances of the electrochemical cell 400 in accordance with various embodiments. The module 503 may be a generally rectangular configuration with the sides of the module 503 longer than the back and front of the module 503. In the module 503, a single row of instances of the electrochemical cell 400 may be arranged such that the widths of the instances of the electrochemical cell 400 are parallel to the front and back of the module 503 and the depths of the instances of the electrochemical cell 400 are parallel to the sides of the module 502. In the module 503, the widths of the single row of instances of the electrochemical cell 400 may generally govern the length of the front and back of the module 503 along with any spacing between the sides of the module 503. The number instances of the electrochemical cell 400 in the row and the depth of the instances of the electrochemical cell 400 may generally govern the length of the sides of the module 503 along with the spacing between the instances of the electrochemical cell 400 in the row and the spacing between the front and back of the module 503.

As yet another example, referring now to FIG. 5D a module 504 may be generally square with the front, back, and sides of the module 504 about the same lengths. In the module 504, two rows of instances of the electrochemical cell 400 may be arranged such that the widths of the instances of the electrochemical cell 400 are parallel to the front and back of the module 504 and the depths of the instances of the electrochemical cell 400 are parallel to the sides of the module 504. In the module 504, the widths of the two instances of the electrochemical cell 400 may generally govern the length of the front and back of the module 504 along with any spacing between the rows of instances of the electrochemical cell 400 and spacing of the respective rows and the sides of the module 504. The number of instances of the electrochemical cell 400 in each row and the depths of the instances of the electrochemical cell 400 may generally govern the length of the sides of the module 504 along with the spacing between the instances of the electrochemical cell 400 in each row and the spacing of the respective rows and the front and back of the module 504.

Other configurations, of a plurality of instances of the electrochemical cell are additionally or alternatively possible, such as modules with more or fewer rows, modules with non-linear arrangements of electrochemical cells, modules with more or fewer electrochemical cells, etc., may be substituted for the example configuration of the modules described above and other configurations are in accordance with the various embodiments.

In various embodiments, battery modules having strings of electrochemical cells therein may be enclosed in an enclosure. The enclosure may house one or more instances of a module, with each instance of a module having strings of electrochemical cells therein. In description that follows, enclosures are described with respect to a plurality of instances of the module 501 (FIG. 5A). It shall be appreciated, however, that this is for the sake of clear and efficient description. That is, unless otherwise indicated or made clear from the context, any reference the module 501 (FIG. 5A) in enclosures shall be understood to apply equally to any other arrangement of electrochemical cells in a module and, thus, shall be understood to apply equally to the module 502 (FIG. 5B), to the module 503 (FIG. 5C), and to the module 504 (FIG. 5D).

Instances of the module 501 deployed in the field may need protection from the elements, such as: wind, dust, snow, rain, seismic activity, etc. The instances of the module 501 may also, or instead, need to be secured to the ground to reduce the likelihood of movement in the event of heavy winds and/or seismic activity. Personnel also need to have protections from high voltage, caustic fluids, and any other hazardous conditions associated with the operation of a battery system. There are several auxiliary systems that may also be required to support operating the battery energy storage system, including secondary containment, thermal management, hydrogen management, gas diffusion electrode (GDE) support, air supply, electrolyte/water management, etc.

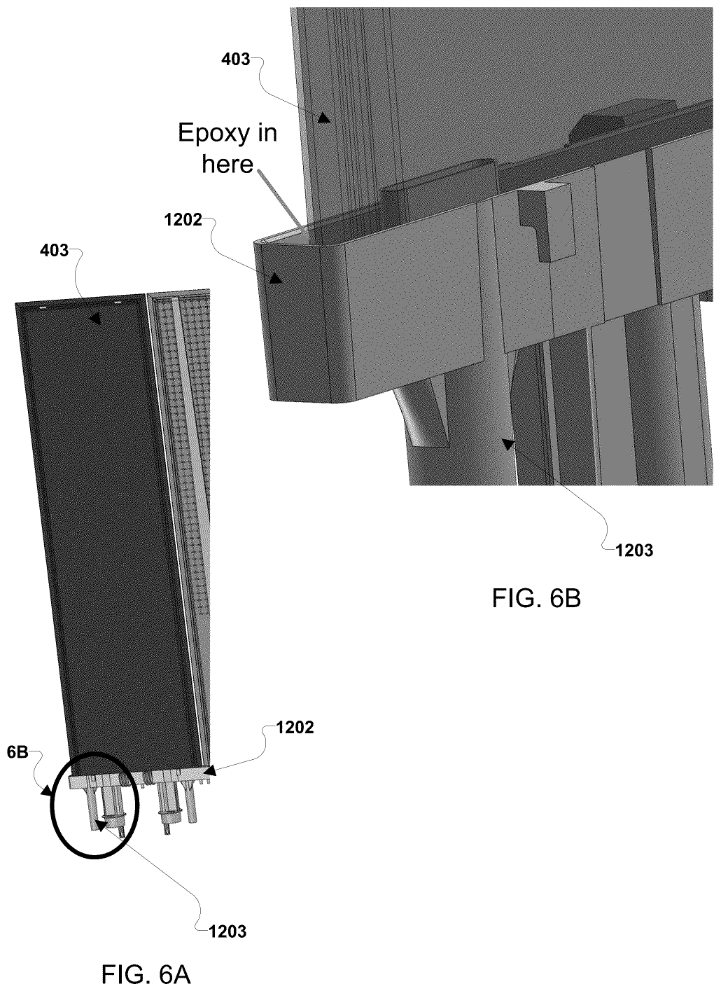

Referring now to FIGS. 6A and 6B, the GDE 404 may be sealed in some instances. For example, the GDE 404 may include a plastic containment piece 1202. The GDE 404 may be an electrode pocket with an open cavity area internal to the GDE 404 and into which air may be passed. During construction of the GDE 404, the GDE 404 may be inverted relative to its operational orientation and inverted epoxy sealing of the top edge of the GDE 404 may be performed to facilitate air passthrough to the active area of the GDE 404 after construction. The GDE 404 pocket may be sealed on the top and final edge by an epoxy potting process that occurs inverted to the operational mode of the GDE 404. The liquid level may fall high enough to wet the electrode area and seal it, and the plastic containment piece 1202 may define passages 1203 to direct air into and out of the GDE 404 that is otherwise sealed.

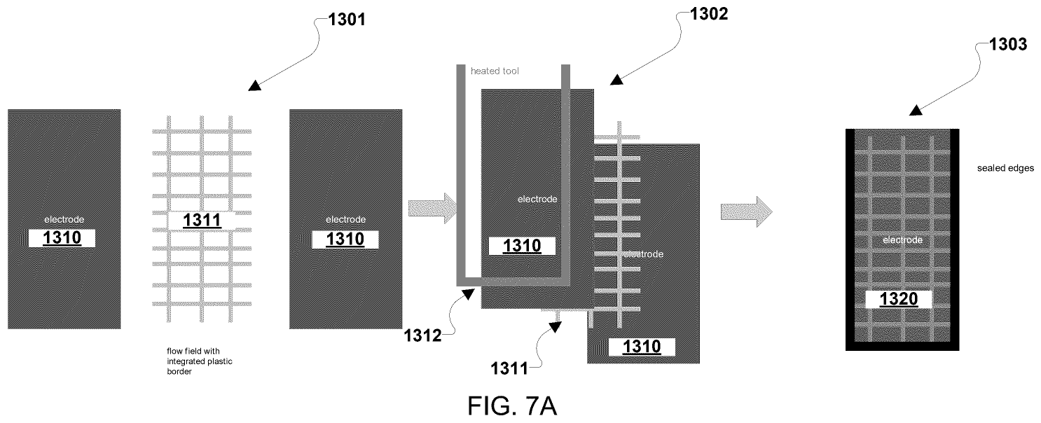

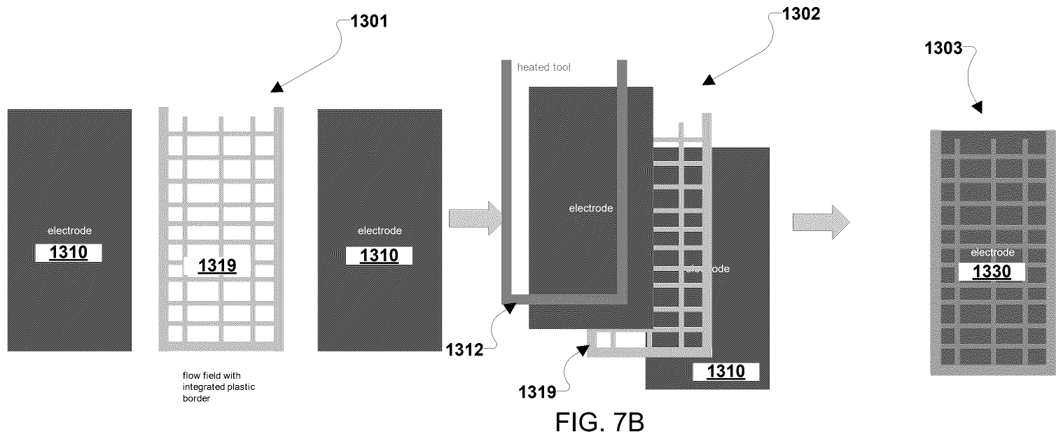

FIG. 7A is a schematic representation of an exemplary process for pressing a flow field 1311 in place during seal lamination of an electrode (e.g., the GDE 404 of FIG. 4B). For example, a flow field may be installed in a bifacial electrode assembly (e.g., the GDE 404 of FIG. 4B) as electrodes are sealed together. Positioning the flow field 1311 between two separate electrode sheets 1310, and applying heat and/or pressure to seal the edges around the flow field 1311 on three sides. Back layers of the electrodes may seal to themselves. For example, in a first step 1301, two separate electrode sheets 1310 may be provided along with a flow field 1311, and the flow field 1311 may be arranged between the two separate electrode sheets 1310. In a next step 1302, a heated tool 1312 may be pressed to the two separate electrode sheets 1310 aligned over one another such that the two separate electrode sheets 1310 are melted together at three sides to form sealed edges and for a bifacial electrode assembly 1320 (e.g., the GDE 404) at step 1303.

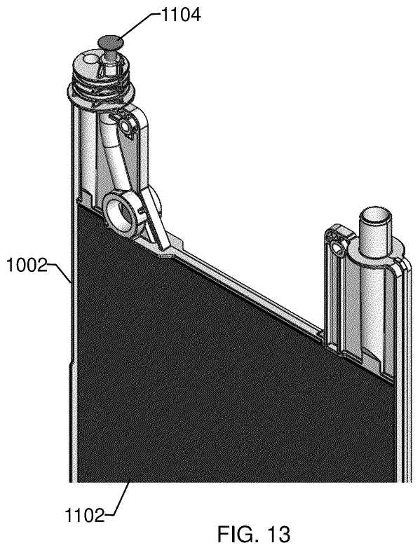

FIG. 7B is a schematic representation of another exemplary process for pressing an air flow field in place during seal lamination of an electrode (e.g., the GDE 404 of FIG. 4B). The exemplary process of FIG. 7B is similar to the exemplary process shown in FIG. 13A, except the exemplary process shown in FIG. 7B includes using a flow field 1319 with an integrated boarder that overlaps the seal between the two separate electrode sheets 1310. According to this approach, heat and/or pressure may be applied by the tool 1312 to seal the edges around the flow field 1319, and a plastic border of the flow field 1319 may act the sealing medium to form a bifacial electrode assembly 1330.

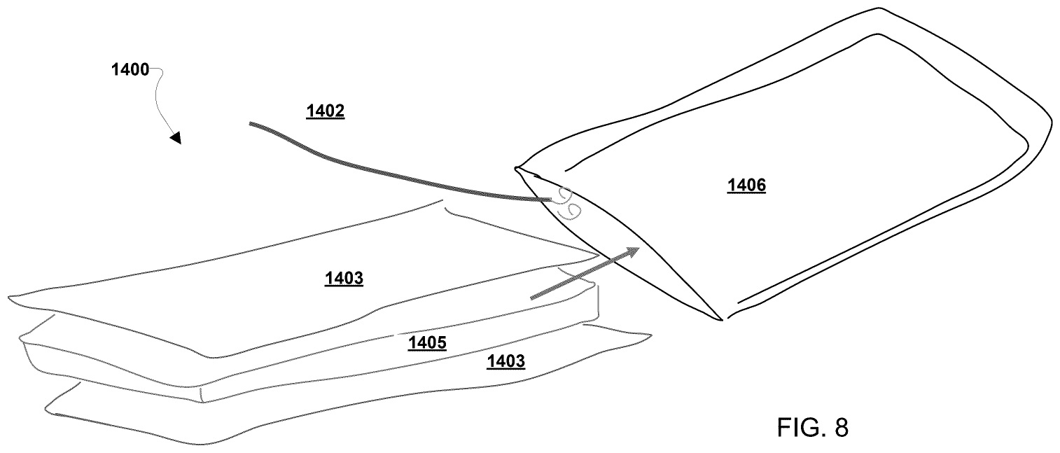

FIG. 8 is a schematic representation of an exemplary method 1400 for inserting a flow field 1405 into a pre-sealed electrode assembly 1406 to form an electrode (e.g., the GDE 404 of FIG. 4B). For example, a pre-sealed electrode assembly 1406 with three seams sealed to form a pocket may have a flow field 1405 installed according to the exemplary method 1400 by placing slip sheets 1403 of low surface energy plastic on either side of the flow field 1405. Compressed air from an air line 1402 may be blown into the pre-sealed electrode assembly 1406 such that the pocket formed by the pre-sealed electrode assembly 1406 may expand and the slip sheets 1403 and the flow field 1405 may be inserted into the pocket of the pre-sealed electrode assembly 1406. The slip sheets 1403 may be removed after installation such that only the flow field 1405 is left in place in the pocket defined by the pre-sealed electrode assembly 1406.

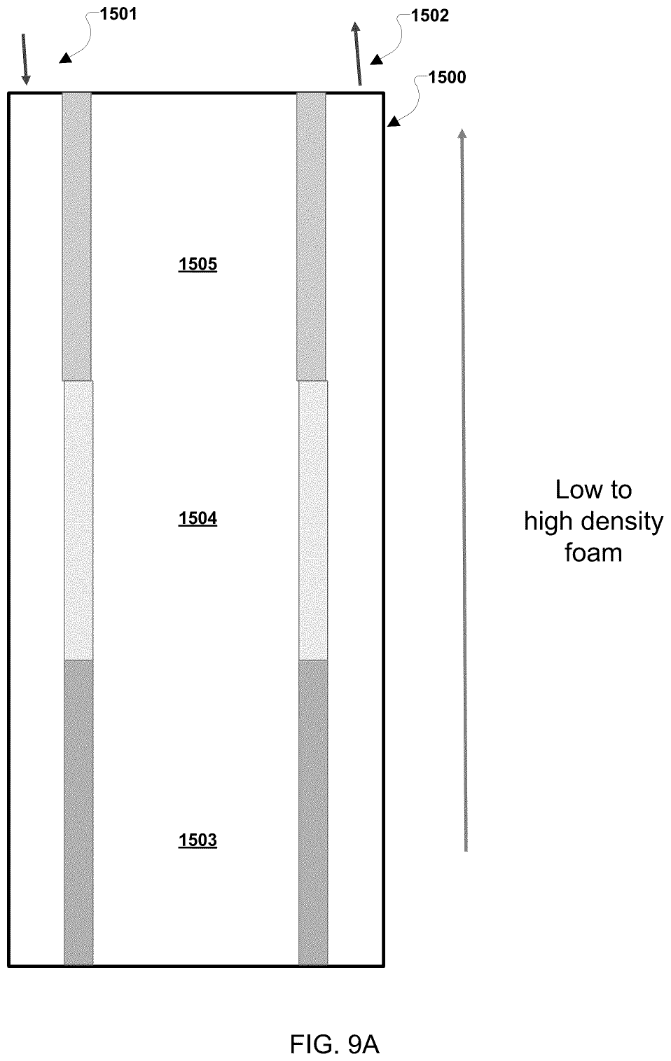

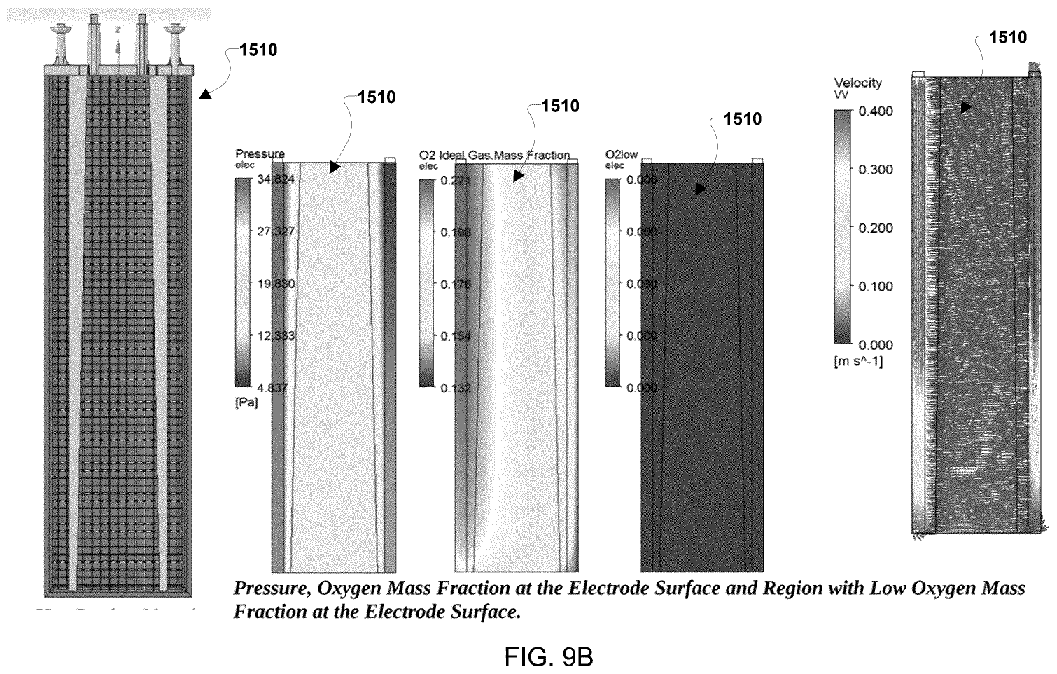

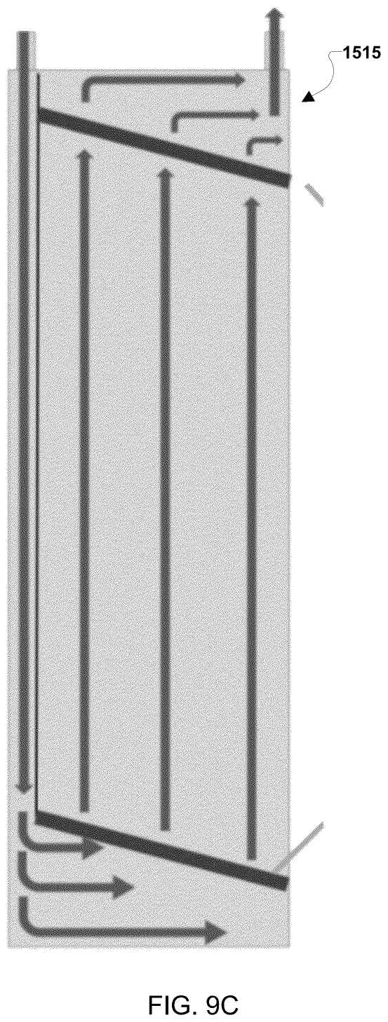

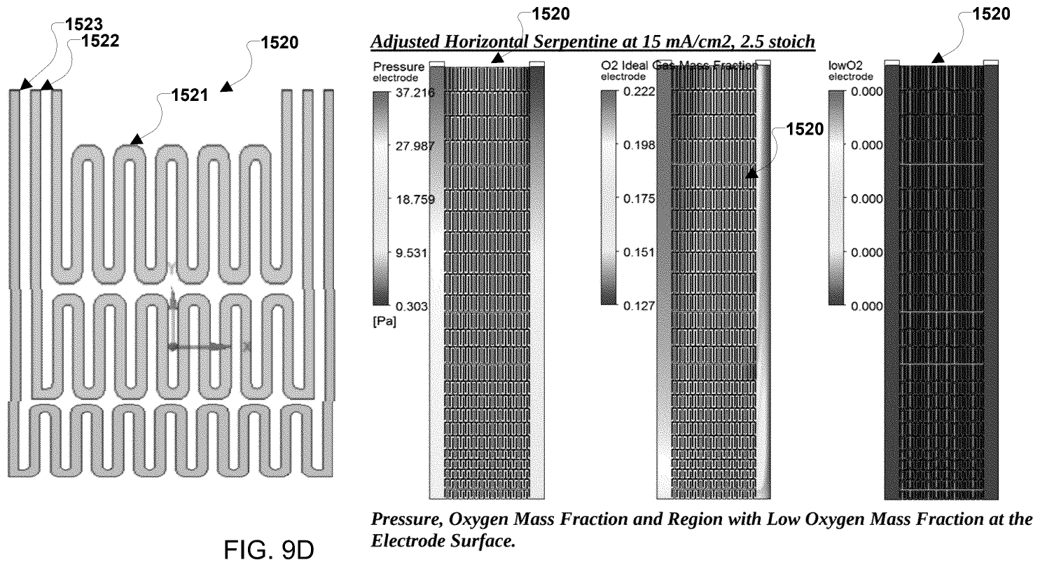

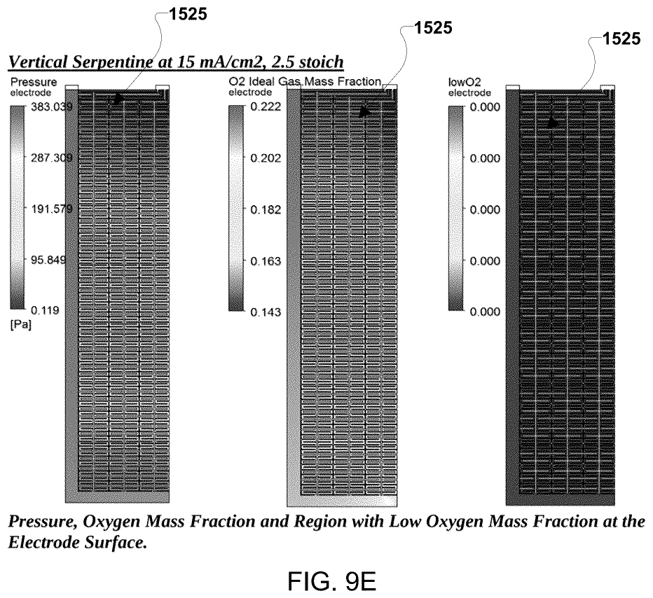

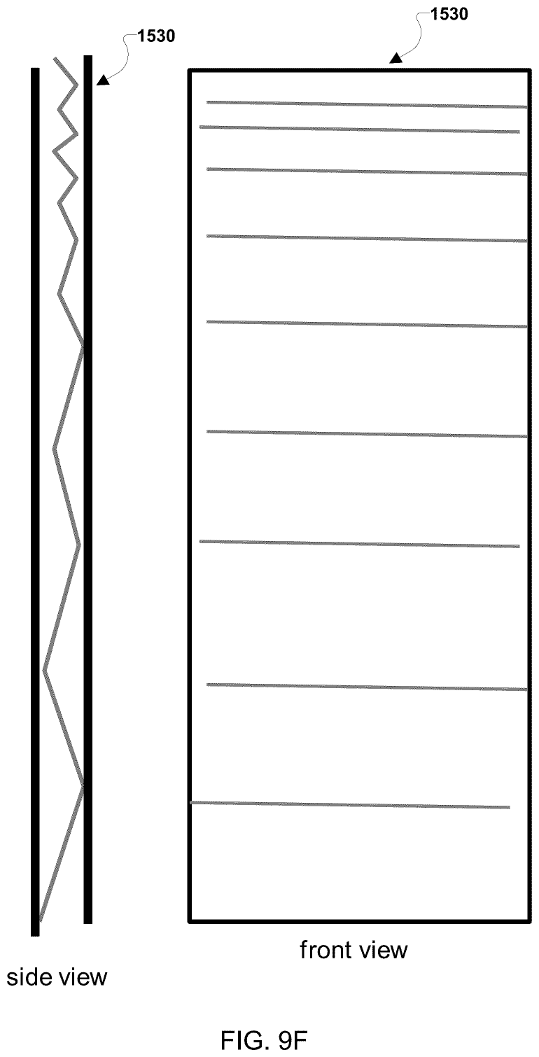

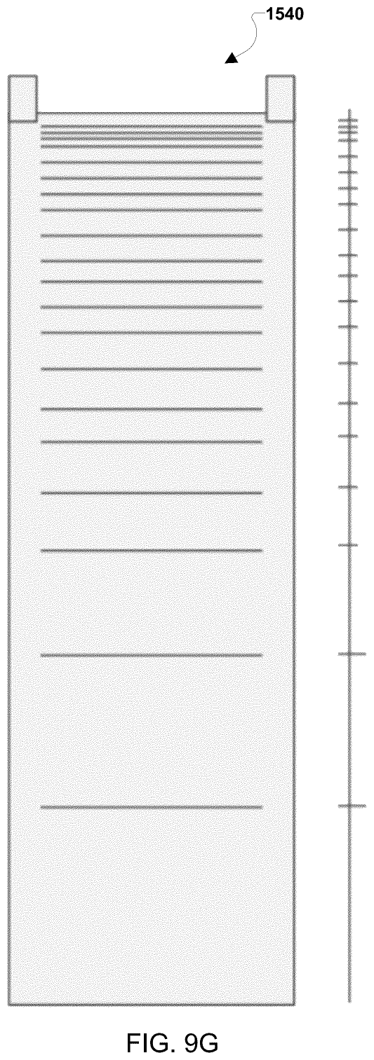

Referring now to FIG. 9A, the flow field 1500 may include porous media such that an electrode (e.g., the GDE 404 of FIG. 4B) may be formed with a low pressure, high uniformity flow between two electrode plates (e.g., between the first portion 404a of the GDE 404 and the second portion 404b of the GDE 404 of FIG. 4C and/or between the first portion 404a′ and the second portion 404b′ of the GDE 404′ of FIG. 4D). In the flow field 1500, air may be substantially uniformly distributed across a long and narrow active area of the electrode, using symmetrical stacks of open cell foam 1503, 1504, 1505 of varying porosities to facilitate controlling pressure drop across the surface. For example, the open cell foam 1503 may have lower density than the open cell foam 1504, and the open cell foam 1505 may have a higher density than each of the open cell foam 1503 and the open cell foam 1504. Air may enter the flow field 1500 at an inlet opening 1501 and exit the flow field 1500 from an outlet opening 1502 after passing through the open cell foam 1503, the open cell foam 1504, and/or the open cell foam 1505. The flow field 1500 may also, or instead, mechanically and/or electrically isolates the two faces of the electrode from one another, providing a mechanical cavity for air to access the electrode. In instances in which the flow field 1500 is formed of foam, the flow field 1500 may include pins therein to keep the two faces of the electrode from touching one another.

FIG. 9B shows computational fluid dynamic/finite element analysis simulation results of a flow field 1510 in which air is uniformly distributed across a long, narrow active area of an electrode (e.g., the GDE 404 of FIG. 4C and/or the GDE 404′ of FIG. 4D) using two symmetrical opposing strips of filter felt with a tapered geometry to balance pressure drop across the inlet to the outlet of the electrode.

FIG. 9C is a schematic representation of a flow field 1515. Generally, the flow field 1515 is similar to the flow field 1510 (FIG. 9B), except the flow field 1515 uses a vertical feed and laterally positioned porous media strips to control and distribute airflow.

FIG. 9D shows computational fluid dynamic/finite element analysis simulation results of a flow field 1520 having a low pressure and high uniformity and formed using horizontal serpentine channels 1521, 1522, 1523 of varying heights. The flow field 1520 may substantially uniformly distribute air across a long and narrow active area of an electrode (e.g., such as between the first portion 404a of the GDE 404 and the second portion 404b of the GDE 404 in FIG. 4C and/or between the first portion 404a′ and the second portion 404b′ of the GDE 404′ in FIG. 4D) using the horizontal serpentine channels 1521, 1522, 1523, which may be symmetrically stacked and have decreasing height from top to bottom to achieve a uniform path length from inlet to outlet across the entire surface. The flow field 1520 may also, or instead, be resistant to flooding in that an electrolyte in the bottom of the flow field 1520 may not choke flow to the entire electrode.

FIG. 9E shows computational fluid dynamics/finite element analysis simulation results of a flow field 1525 including vertical serpentine channels fed by a vertical inlet running from the top of the flow field 1525 to the bottom of the flow field 1525. Air may be fed down to the bottom of the flow field 1525 and dispersed across the vertical serpentine channels across the main portion of the active area up to the outlet.

FIG. 9F is a schematic representation a long, narrow active area of an electrode including accordion folds of increasing height from top to bottom to form a flow field 1530. Smaller, more restrictive channels are created by bends toward the top of the active area, whereas more open flow occurs at the bottom of the flow field 1530.

FIG. 9G is a schematic representation of a long, narrow active area of an electrode including a ladder structure having increasing spacing from the top to the bottom of the electrode to form a flow field 1540.

Using less inactive material in each electrochemical cell may help decrease the system cost, size, and/or weight with little or no loss in performance. A vessel for an electrochemical cell serves the dual purpose of isolating instances of electrochemical cells from one another, and providing structural support to hold the shape of each instance of the electrochemical cell. The amount of inactive material needed to fulfill this functionality can result in large costs and decrease energy density of the electrochemical cell. By moving the structural functionality from the level of individual instances of the electrochemical cell to the level of the module, the primary purpose of the vessel may be to provide electrical insulation. This can be achieved, for example, by using thin plastic bags to house each electrochemical cell, with structural end walls to sandwich the bags together. This decreases the amount of material needed, thereby decreasing overall cost.

Having described various aspects of metal-air batteries including gas diffusion electrodes, attention is now directed to certain aspects of efficient and cost-effective fabrication of discharge cathode assemblies including gas diffusion electrodes. In metal-air batteries, gas diffusion electrodes facilitate electrochemical reactions by providing oxygen to interact with an electrolyte while maintaining electrical continuity with external circuitry of the metal-air battery and/or a module including a plurality of metal-air batteries. Thus, proper sealing of gas-diffusion electrodes reduces the likelihood of electrolyte leakage, thus promoting stable operation of the metal-air battery over extended durations. However, such sealing for reducing the likelihood of electrolyte leakage is in tension with considerations associated with achieving reliable electrical connections between external busbars and external terminals of the discharge cathode assembly.

To address these disparate design challenges, discharge cathode assemblies of the present disclosure may include sealed electrical connections between gas diffusion electrodes and external circuitry. As described in greater detail below, such sealed electrical connections may include overmolding a terminal into an insulating frame, incorporating a busbar segment into the electrode assembly, and/or establishing an electrical connection through a sealed window in the frame. The electrical connection may be formed using one or more of welding, soldering, crimping, conductive adhesives, or other bonding techniques. Once the electrical connection is established, a window in the insulating frame may be hermetically sealed to facilitate fluidically isolating the gas diffusion electrode from external contaminants while maintaining an electrically conductive path for current flow from the gas diffusion electrode to electric circuitry outside of the discharge cathode assembly. As compared to other approaches to fabrication of discharge cathode assemblies, the fabrication techniques described herein for balancing the competing considerations of forming robust electrical connections while maintaining sealing around the gas diffusion electrode may reduce cost, improve initial performance, and/or improve reliability of metal-air battery systems. For example, the fabrication techniques described herein mitigate the challenges associated with forming blind electrical joints inside the air cavity of a discharge cathode assembly, reducing manufacturing complexity and enhancing the consistency of electrical performance.

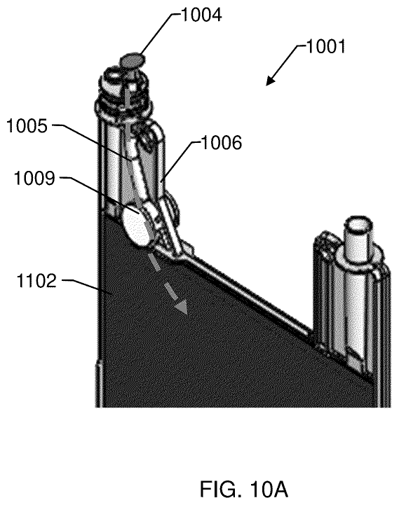

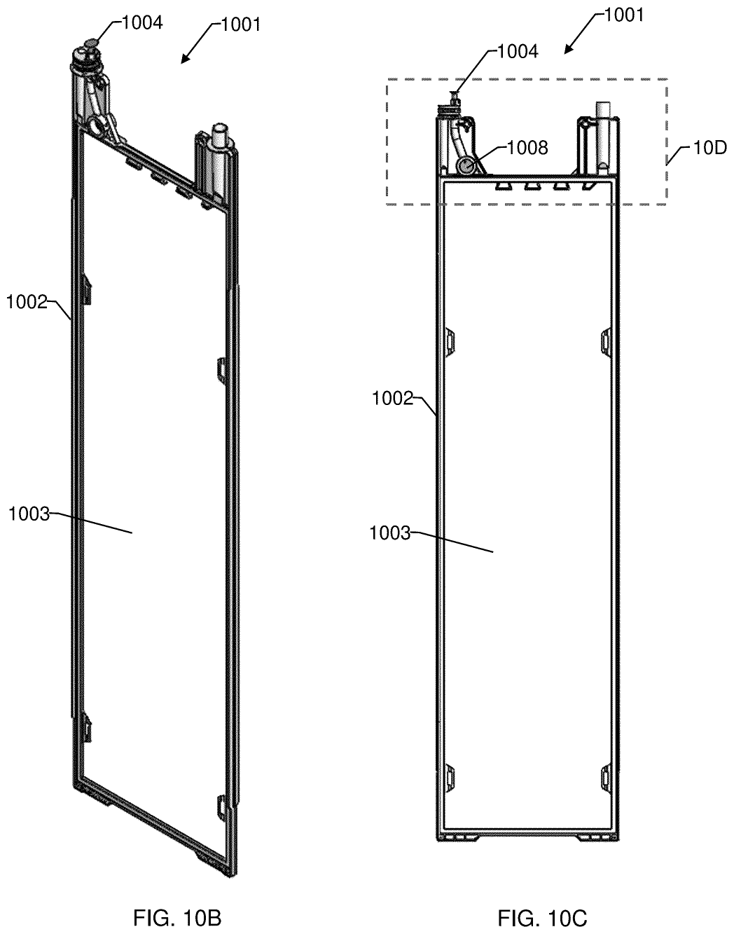

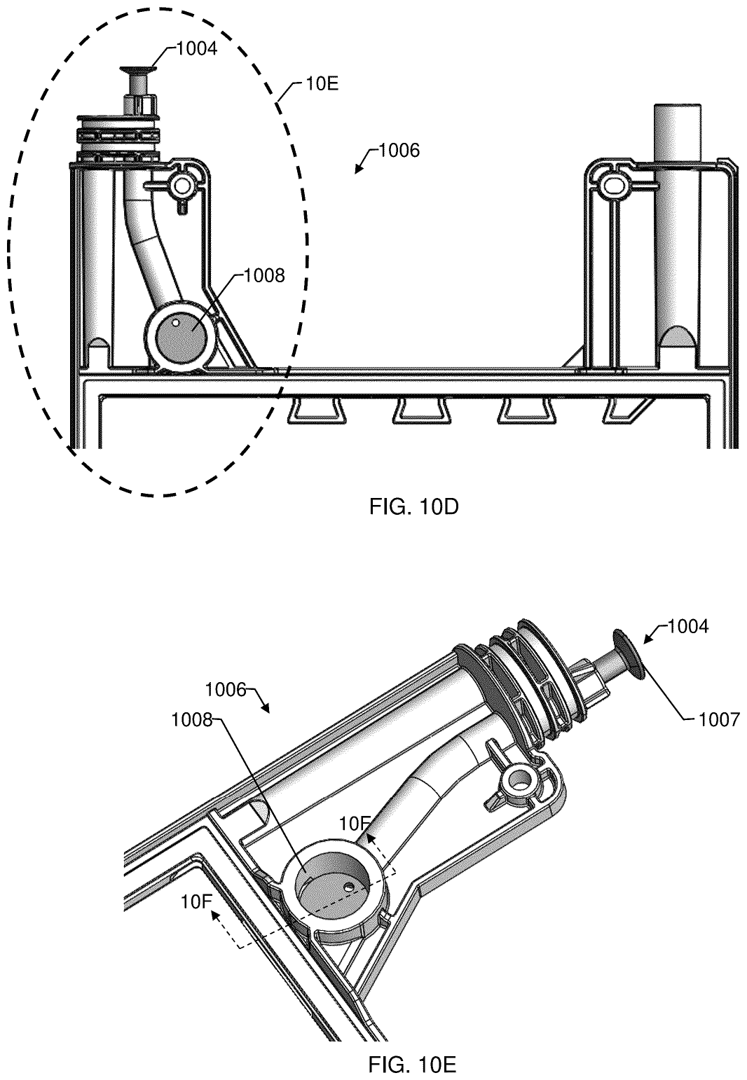

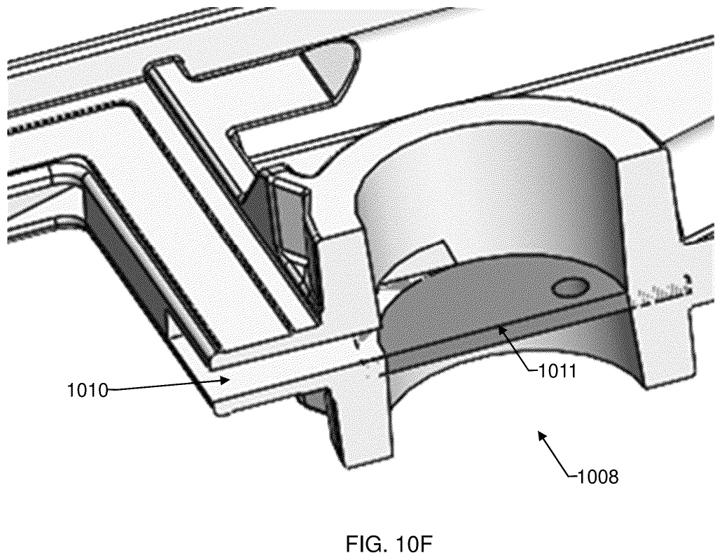

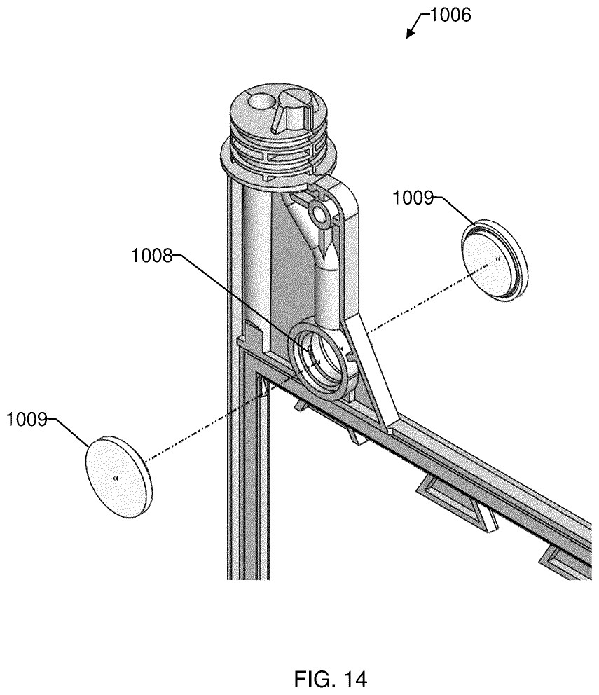

Referring now to FIGS. 10A-10C, FIGS. 11A-11E, FIG. 13, and FIG. 14, a discharge cathode assembly 1000 may include a frame 1002 having a terminal support section 1006. The frame 1002 may be formed from an electrically insulating material, such as a polymer, to provide structural support for the electrode assembly while electrically isolating internal components of the discharge cathode assembly 1000. Suitable materials for the frame 1002 include thermoplastics such as polypropylene, polyethylene, acrylonitrile butadiene styrene (ABS), polyether ether ketone (PEEK), or other high-performance polymers that offer mechanical stability and chemical resistance in electrochemical environments. The frame 1002 may be fabricated through injection molding, overmolding, or other forming techniques producing consistent dimensions and robust integration of a terminal 1004 within the terminal support section 1006.

The frame 1002 may define an opening 1003 into which a gas diffusion electrode 1102 is introducible. The terminal support section 1006 may be positioned along an edge of the frame 1002 (e.g., an upper edge). Further, or instead, the frame 1002 may accommodate an overmolded terminal 1004, which may form a portion of an electrically conductive path 1005 the gas diffusion electrode 1102 and an external circuit (e.g., the electronics structure 450 in FIG. 4B). The terminal support section 1006 may define a window 1008, through which a portion of the terminal 1004 is exposed to facilitate electrical coupling with an electrode busbar, as described in greater detail below.

In certain implementations, the frame 1002 may have a generally rectangular shape, with dimensions of the opening 1003 matching the size and geometry of the gas diffusion electrode 1102. Along the opening 1003, the frame 1002 may include one or more features facilitating coupling to the gas diffusion electrode 1102. Further, or instead, outer edges of the frame 1002 may include sealing features, such as raised ridges or recessed channels, to facilitate bonding with adjacent components in an electrochemical cell stack to achieve structural integrity and fluidic isolation within the electrochemical cell.

In some implementations, the frame 1002 may be reinforced with additional structural elements, such as internal ribs or embedded fiber reinforcements, to enhance mechanical strength with little or no increase in weight. The material composition and shape of the frame 1002 may further, or instead, facilitate withstanding thermal cycling, mechanical stresses, and/or exposure to reactive species in the electrochemical environment for long-term reliability of the assembled electrode structure.

The terminal 1004 may be an electrically conductive component embedded (e.g., overmolded) within the frame 1002 to facilitate electrical connectivity between the gas diffusion electrode 1102 and an external circuit. The terminal 1004 may be formed from a metal or metal alloy with high electrical conductivity and corrosion resistance, such as copper, nickel, aluminum, or a nickel-plated or tin-plated variant of these materials. The shape of the terminal 1004 may accommodate both secure integration within the frame 1002 and reliable electrical interfacing with external connectors.

A portion of the terminal 1004 may be exposed through the window 1008 defined by the terminal support section 1006. That is, the window 1008 may be an opening in the insulating material of the frame 1002, allowing access to a portion of the terminal 1004 extending through the window 1008. Such access to the portion of the terminal 1004 through the window 1008 may facilitate making electrical connections during fabrication of the discharge cathode assembly 1001. That is, as described in greater detail below, the terminal 1004 extending through the window 1008 may serve as a contact point for a busbar or other conductive element extending from the gas diffusion electrode 1102, as described in greater detail below. As also described in greater detail below, this configuration may facilitate establishing electrical connections while maintaining the integrity of the sealed air cavity within an electrochemical cell.

The terminal 1004 may have a flat or contoured geometry, depending on the connection method used. In some implementations, the terminal 1004 may include a raised surface or an embossed surface within the window 1008 to facilitate welding or other bonding techniques. Alternatively, or in addition, the terminal 1004 may feature a tab protruding into the window 1008, and the tab may be folded or crimped to mechanically reinforce the electrical connection made between the terminal 1004 and a busbar within the window 1008, as described in greater detail below. Further, or instead, the width and thickness of the terminal 1004 may balance considerations associated with electrical resistance while providing robust connection and compatibility with the frame 1002 and busbar attachment.

The window 1008, which may be circular or another shape useful for providing access, may accommodate making an electrical connection (e.g., providing accessibility with little or no need for specialized tooling) while reducing the likelihood of the window 1008 itself acting as a potential pathway for leakage. After the electrical connection is made, the window 1008 may be hermetically sealed using caps 1009, which may snap fit into the window 1008 and additionally, or alternatively, may be secured in place in the window 1008 using adhesive and/or welding. The positioning and dimensions of the window 1008 within the terminal support section 1006 may balance manufacturability, electrical performance, and structural stability of the frame 1002.

The frame 1002 may define a slot 1010 through which a bus tab 1108 may extend into direct contact with the terminal 1004 such that the bus tab 1108 and the terminal 1004 may be connected to one another, as described in greater detail below. The slot 1010 may be defined by the insulating material of the frame 1002, with the slot 1010 providing a controlled pathway for routing electrical connections while maintaining structural integrity of the frame 1002. The bus tab 1108 may be inserted into the slot 1010 with minimal clearance, reducing the potential for movement or misalignment of the bus tab 1108 to the terminal 1004 during assembly.

The window 1008 may provide external access to a first end portion 1011 of the terminal 1004 for establishing an electrical connection to the bus tab 1108, while the slot 1010 may facilitate routing the bus tab 1108 through the frame 1002 and into contact with the first end portion 1011 of the terminal 1004 at the position of the window 1008. Thus, it shall be appreciated that the window 1008 may facilitate forming a consistent and robust electrical joint between the bus tab 1108 and the terminal 1004. As described in greater detail below, the window 1008 may be sealed after the electrical joint has been formed, thus satisfying enclosure requirements for operation of the gas diffusion electrode 1102.

The frame 1002 may include structural reinforcements around the slot 1010 to reduce the likelihood of unintended deformation of the bus tab 1108 as the bus tab 1108 is introduced into the slot 1010 for connection to the first end portion 1011 of the terminal 1004. As an example, the slot 1010 may be formed as part of a molding process in the formation of the frame 1002. Further, or instead, the slot 1010 may be machined after molding the frame 1002 to facilitate achieving precise tolerances between the slot 1010 and the bus tab 1108. The geometry of the bus tab 1108 may accommodate variations in thickness, with tapered or stepped features to facilitate assembly and improve mechanical stability.

In general, a busbar 1104 may be attached to the gas diffusion electrode 1102, and the bus tab 1108 may be attached to the busbar 1104 such that the bus tab 1108 extending from the busbar 1104 may be routed through the slot 1010 in the frame 1002 and positioned for electrical connection to the first end portion 1011 of the terminal 1004. Such extension of the bus tab 1108 from the busbar 1104 may be useful for establishing a reliable and low-resistance electrical pathway to the terminal 1004 while maintaining the manufacturability and structural stability of the gas diffusion electrode 1102.

The connection of the busbar 1104 to the gas diffusion electrode 1102 may include on or more of welding, soldering, or other joining techniques to affix the busbar 1104 securely to the gas diffusion electrode 1102 before the bus tab 1108 is inserted into the frame 1002. As an example, the busbar 1104 may be pre-formed or pre-shaped during assembly to facilitate alignment of the slot 1010 with the bus tab 1108 extending from the busbar 1104. With the bus tab 1108 extending through the slot 1010 and into contact with the first end portion 1011 of the terminal 1004 within the window 1008, the bus tab 1108 may be secured to the first end portion 1011 of the terminal 1004 to form an electrical joint. With the electrical joint formed within the window 1008, the caps 1009 may be secured in place subsequent sealing of the window 1008 such that the frame 1002 may be installed in a sealed configuration for operation of the gas diffusion electrode 1102.

The busbar 1104 may extend along an edge (e.g., a shortest edge) of the gas diffusion electrode 1102, providing a portion of the conductive path 1005 for current flow between the gas diffusion electrode 1102 and a second end portion 1007 of the terminal 1004 such that the gas diffusion electrode 1102 may be connected in electrical communication with external circuitry of the electrochemical cell. In some implementations, the busbar 1104 may be connected to the bus tab 1108 via a connection tab 1106 to facilitate fabrication and alignment of the bus tab 1108 insertable into the slot 1010 of the frame 1002 for electrical connection to the terminal 1004.

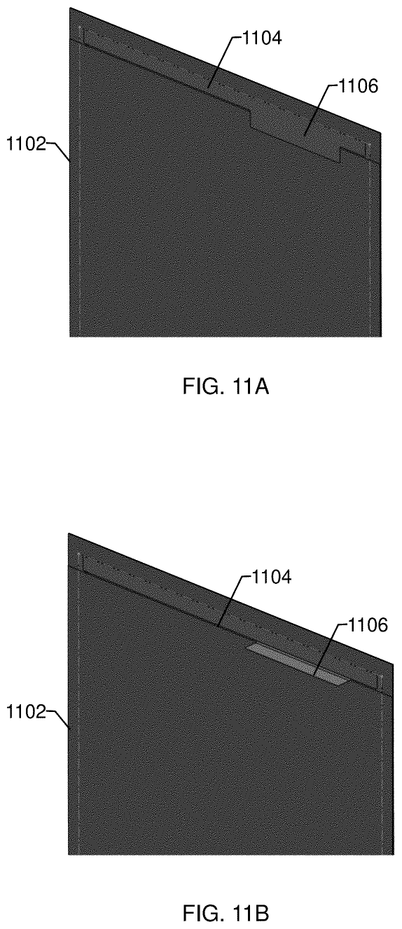

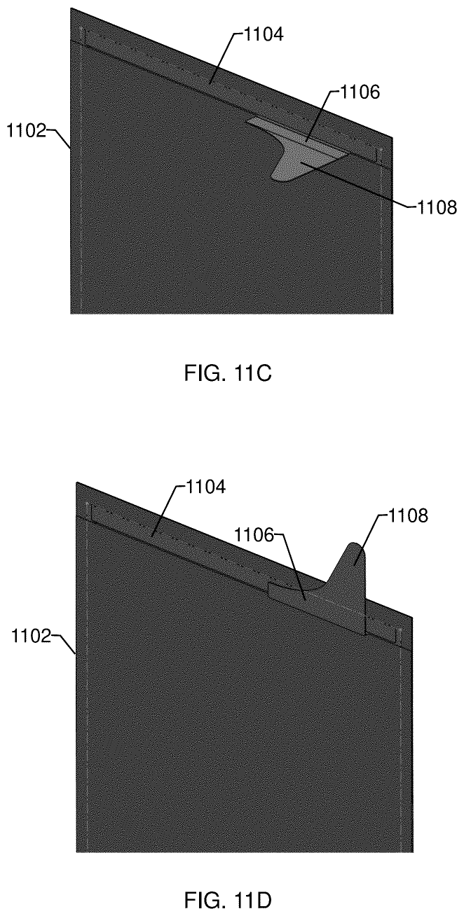

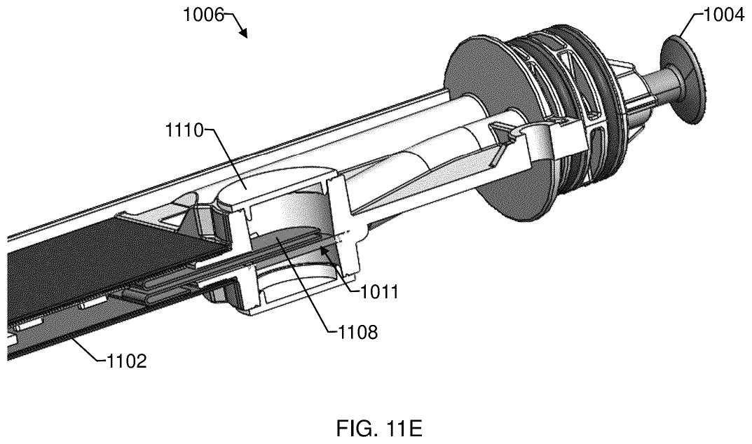

The busbar 1104 may be formed from a conductive material such as nickel, copper, or a plated variant thereof to facilitate efficient charge transfer. The connection tab 1106 may initially extend perpendicularly from the busbar 1104 and serve as an attachment point for the bus tab 1108. The positioning of the busbar 1104 along the edge of the gas diffusion electrode 1102 may facilitate establishing an electrical connection in a controlled and repeatable manner during assembly of the discharge cathode assembly 1001. The connection tab 1106 may be flexible to facilitate subsequent manufacturing steps, including bending, welding, or folding operations to align the bus tab 1108 with the slot 1010 in the frame 1002. For example, the connection tab 1106 may be initially flat on a surface of the gas diffusion electrode 1102 and may be bent to a position perpendicular to the surface of the gas diffusion electrode 1102 (compare FIGS. 11A and 11B), preparing the connection tab 1106 for connection to the bus tab 1108. The folding of the connection tab 1106 may facilitate achieving proper alignment with the slot 1010 in the frame 1002 while maintaining electrical continuity between the gas diffusion electrode 1102 and the terminal 1004. The connection tab 1106 may be folded, for example, along a predefined bend line, which may be formed during the manufacturing process to control the bending angle and reduce mechanical stress at the interface between the connection tab 1106 and the busbar 1104. The bending operation may be performed using precision tooling to achieve consistent placement and orientation across multiple electrodes in a production setting. Depending on the material composition of the busbar 1104, the connection tab 1106 may be annealed before or after bending to improve ductility and reduce the risk of cracking.

With the connection tab 1106 extending in a direction perpendicular to a surface of the gas diffusion electrode 1102, the bus tab 1108 may be connected to the connection tab 1106 (FIG. 11C). With the bus tab 1108 attached to the connection tab 1106, the connection tab 1106 may be folded such that the bus tab 1108 extends beyond an edge of the gas diffusion electrode 1102 such that the bus tab 1108 may be inserted into the slot 1010 and extend into the window 1008 of the frame 1002.

The bus tab 1108 may be formed from the same conductive material as the busbar 1104 (e.g., nickel, copper, or a plated variant), as may be useful for consistent electrical properties and reliable performance. The attachment of the bus tab 1108 to the connection tab 1106 may include welding techniques such as resistance welding, laser welding, ultrasonic welding, or soldering, depending on the specific manufacturing requirements and material properties. The weld joint between the connection tab 1106 and the bus tab 1108 may provide low electrical resistance and high mechanical strength to withstand operational stresses.

The length of the bus tab 1108 may provide proper positioning of the bus tab 1108 relative to the window 1008 of the frame 1002 while making efficient use of material that may otherwise introduce undesirable cost and weight to the system. The bus tab 1108 may be long enough to establish a robust connection with the first end portion 1011 of the terminal 1004 while remaining within the designed constraints of the discharge cathode assembly 1001.

As the bus tab 1108 is inserted through the slot 1010, positioning of the bus tab 1108 may be controlled to increase the likelihood of consistent electrical contact with the first end portion 1011 of the terminal 1004. The insertion process may involve guiding fixtures or automated assembly techniques to achieve repeatable and precise alignment. In some instance, the bus tab 1108 may be temporarily held within the frame 1002 prior to final attachment to the first end portion 1011 of the terminal 1004.

Once the bus tab 1108 is fully inserted into the slot 1010, the bus tab 1108 is positioned for final electrical attachment to the first end portion 1011 of the terminal 1004. At this stage, the bus tab 1108 may be welded to the first end portion 1011 of the terminal 1004 to establish a permanent electrical connection. The welding process may include resistance welding, laser welding, ultrasonic welding, or other suitable bonding techniques, depending on material compatibility and manufacturing constraints. The weld joint between the bus tab 1108 and the first end portion 1011 of the terminal 1004 may have low electrical resistance and high mechanical strength to increase long-term reliability of the discharge cathode assembly 1001. In some implementations, alternative joining methods such as soldering, conductive adhesive bonding, or mechanical fastening may be used instead of or in conjunction with welding.

After final electrical connection of the bus tab 1108 to the first end portion 1011 of the terminal 1004, the window 1008 may be sealed to maintain the integrity of the enclosed air cavity. The sealing process reduces the likelihood of external contaminants, such as moisture or particulates, from entering the enclosed space in the vicinity of the gas diffusion electrode 1102 while increasing the long-term stability of the electrical connection. For example, the caps 1009 may be secured over the window 1008 to create an airtight barrier over the window 1008. The caps 1009 may be formed from a non-conductive material, such as a thermoplastic or thermosetting polymer, to maintain electrical isolation while providing mechanical protection. The caps 1009 may be pre-formed and designed to fit precisely over the window 1008, aligning with the surrounding structure of the terminal support section 1006. Various attachment methods may be used to secure the caps 1110 to the frame 1002. In some implementations, the caps 1110 may be welded in place using ultrasonic welding, laser welding, hot plate welding, or impulse welding, ensuring a fused and permanent seal. Alternatively, the caps 1110 may be affixed using adhesives, such as epoxy or thermally cured resins, which provide both mechanical strength and environmental sealing. In some configurations, potting compounds may be dispensed into the window 1008 and cured in place, forming a continuous seal around the electrical joint.

The gas diffusion electrode 1102 may be positioned within the frame 1002 such that the busbar 1104 aligns with the slot 1010, facilitating subsequent insertion and welding of the bus tab1108 to the terminal 1004. The bonding process of the gas diffusion electrode 1102 to the frame 1002 may secure the gas diffusion electrode 1102 while resisting shifting or misalignment that could compromise the electrical communication between the gas diffusion electrode 1102 and the terminal 1004. The bond between the gas diffusion electrode 1102 and the frame 1002 may include film adhesives, liquid adhesives, heat sealing, ultrasonic welding, or a combination of these techniques. Film adhesives may provide a uniform bond layer, providing consistent adhesion across the surface of the gas diffusion electrode 1102, while liquid adhesives may be dispensed precisely to targeted areas before curing. Heat sealing and ultrasonic welding are alternative methods that may create strong, permanent bonds by fusing the materials together at the molecular level. The bonding process may maintain the gas-tight integrity of the air cavity, ensuring that oxygen supplied to the gas diffusion electrode 1102 is properly contained within the electrochemical cell.

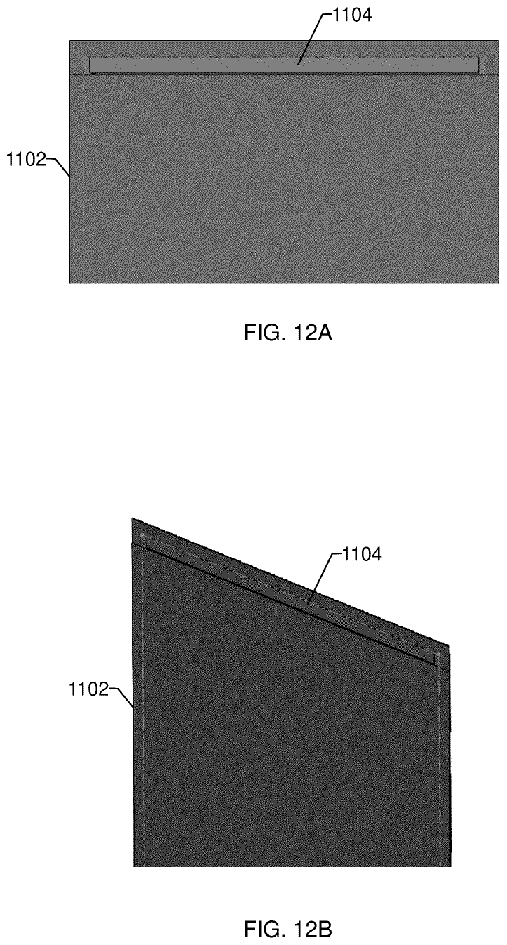

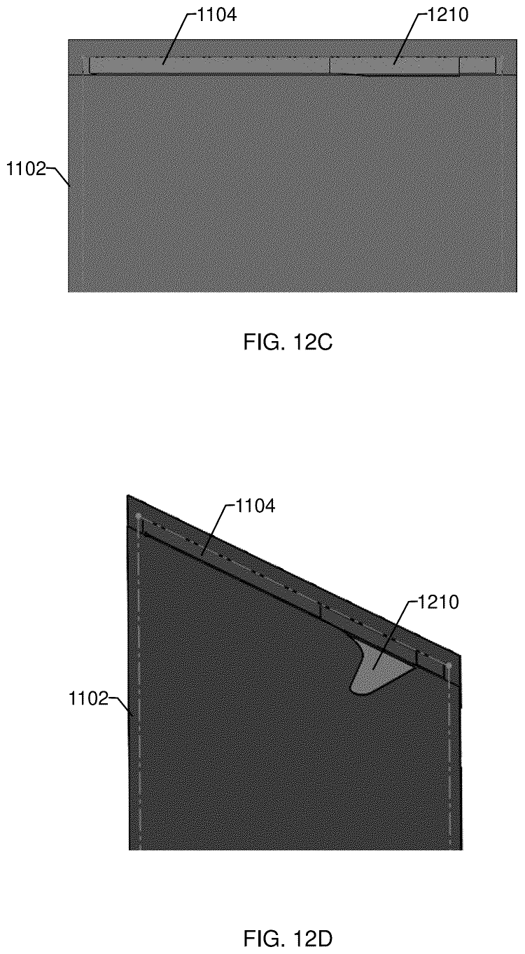

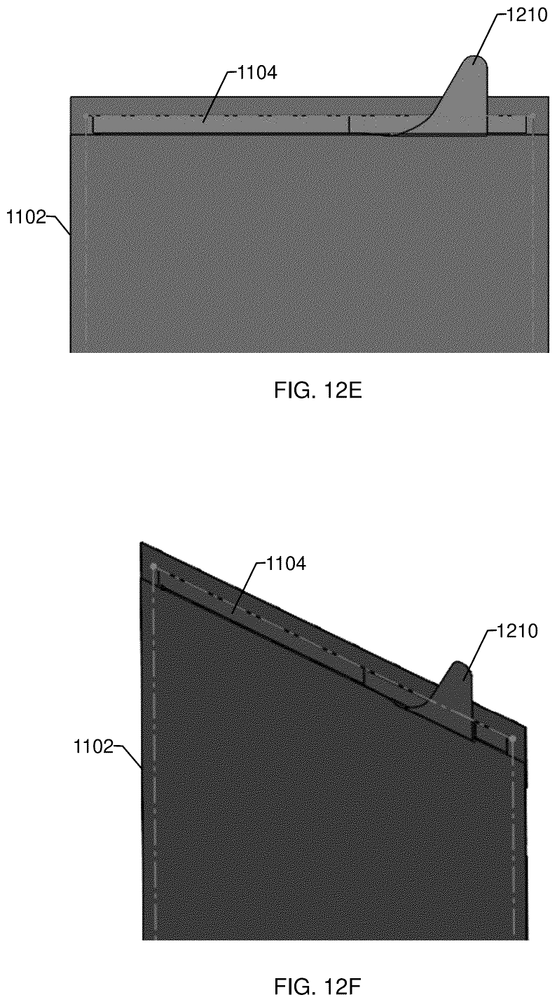

FIGS. 12A-12F illustrate an alternative approach for forming and connecting a vertical busbar segment to an electrode and feeding the segment through a frame. In this configuration, the vertical busbar segment may be integrated into the initial busbar structure rather than being attached as a separate component. This approach may reduce the number of welding steps and simplify assembly by pre-forming the vertical segment as part of the busbar during lamination.

FIG. 12A is a front view of the gas diffusion electrode 1102 and the busbar 1104 as laminated, and FIG. 12B is a perspective view of the gas diffusion electrode 1102 and the busbar 1104. The busbar 1104 may extend along an edge of the gas diffusion electrode 1102. In this alternative configuration, the busbar 1104 may be initially formed in a planar arrangement, integrated with the gas diffusion electrode 1102 during the lamination process. This method incorporates a pre-formed extension of the busbar 1104, and this pre-formed extension may be folded to create a bus tab insertable into a slot in the frame.

FIG. 12C is a front view of the busbar 1104 with an L-busbar 1210 welded onto it. FIG. 12D is a perspective view of the L-busbar 1210. In this alternative configuration, the L-busbar 1210 may be introduced as an additional conductive segment that extends from the busbar 1104 and provides a structured transition to a vertical orientation. The L-busbar 1210 may be welded onto the busbar 1104 at a predetermined location, increasing the likelihood of a secure and low-resistance electrical connection while maintaining mechanical stability.

As shown in FIG. 12C, the L-busbar 1210 may be initially oriented in a horizontal position, aligned with the plane of the busbar 1104 before being manipulated into its final configuration. The welding process used to attach the L-busbar 1210 may include resistance welding, laser welding, ultrasonic welding, or other suitable bonding techniques, depending on material selection and manufacturing constraints. The welded joint provides electrical continuity while reinforcing the structural integrity of the busbar assembly.

FIG. 12D provides a perspective view of the L-busbar 1210, showing its geometry and intended function. The L-busbar 1210 may include a segment that extends outward from the busbar 1104 and is foldable into a vertical position in subsequent steps. This pre-formed shape allows for a controlled and repeatable folding operation, eliminating the need for a separate vertical busbar segment to be welded later in the process.

FIG. 12E is a front view of the L-busbar 1210 after folding. FIG. 12F is a perspective view of the folded L-busbar 1210. In this stage, the L-busbar 1210 may be transitioned from its initial horizontal orientation to a vertical position, aligning it for insertion through a (e.g., the slot 1010 in the frame 1002 in FIG. 10F). This folding operation eliminates the need for a separate vertical busbar segment, instead forming the vertical connection directly from the pre-attached L-busbar.

The L-busbar 1210 may be bent along a controlled fold line to ensure a precise transition from the busbar 1104. The bending angle may be selected to align the vertical portion of the L-busbar 1210 with a slot (e.g., the slot 1010 in FIG. 10F), allowing for a smooth insertion during the subsequent assembly steps. The fold may be performed using mechanical forming tools to ensure uniformity and repeatability across multiple assemblies. Depending on the material properties of the busbar, additional processing such as stress relief annealing may be used to prevent fatigue or cracking at the fold.

FIG. 12F provides a perspective view of the L-busbar 1210 in its folded configuration, showing the vertical segment that extends from the busbar 1104. This vertical segment of the L-busbar 1210 may be fed through a slot in a frame and attached to a terminal, according to any one or more of the techniques described herein.

One variation involves the extent of the welded connection between the busbar 1104 and the L-busbar 1210. In some implementations, a full weld may be applied along the interface to maximize electrical conductivity and mechanical stability. A full weld ensures a continuous electrical pathway and reduces the risk of joint failure due to mechanical stress or thermal cycling. However, a partial weld may be advantageous in certain configurations, particularly where process constraints require limiting heat input or where slight flexibility in the joint can accommodate small alignment tolerances. In these cases, a vacuum-assisted lifting process may be used to maintain proper positioning of the busbar segments during welding while ensuring that the welded interface provides sufficient conductivity and mechanical strength.

Other variations may include different methods for feeding the busbar segment through the slot 1010 in the frame 1002. A Z-tab configuration may facilitate extending the busbar through the slot without requiring additional masking or process adjustments. This approach may simplify process automation but may require precise alignment to ensure that the tab maintains proper electrical contact and mechanical stability within the terminal support section 1006. Alternatively, a post-lamination weld can be used to attach the vertical busbar segment after the busbar is already in place, reducing the number of pre-folding steps but introducing the need for additional masking or fixturing during the welding process. The choice between these approaches depends on factors such as automation capabilities, electrode design constraints, and production throughput requirements.

Once the busbar segment is positioned and secured to the terminal 1004, the window 1008 is sealed to maintain the integrity of the enclosed air cavity. The sealing process ensures that no contaminants or external gases enter the electrode assembly, preserving the controlled environment necessary for stable electrochemical operation. Depending on the welding method used, the sealing step may involve ultrasonic welding, laser welding, adhesive bonding, or potting compounds. If the welding process introduces excessive heat or mechanical stress, alternative attachment methods such as conductive adhesives, crimping, or mechanical fasteners may be used to achieve a stable electrical joint while minimizing potential impact on the surrounding frame material.

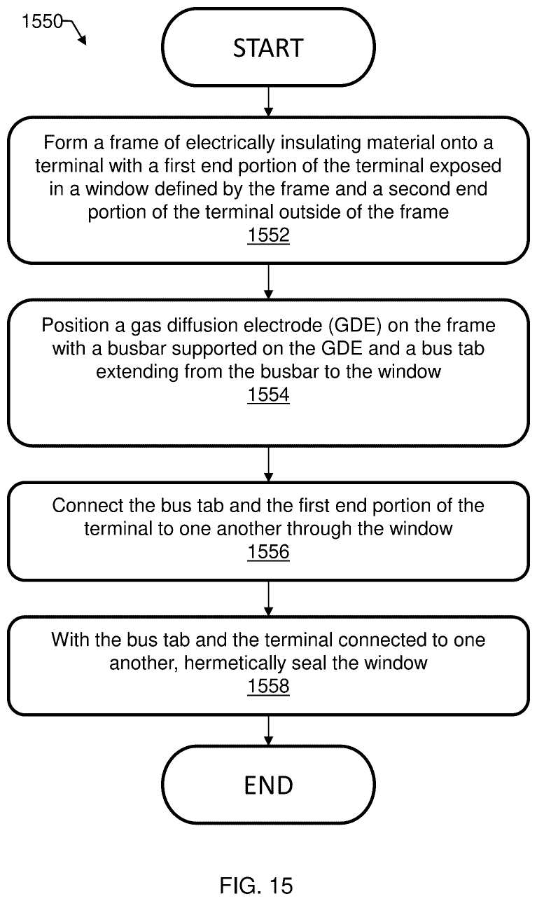

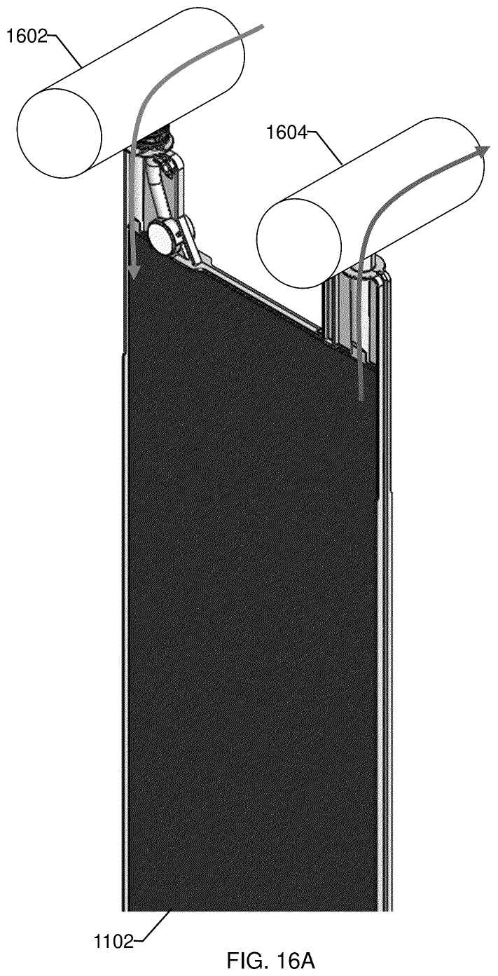

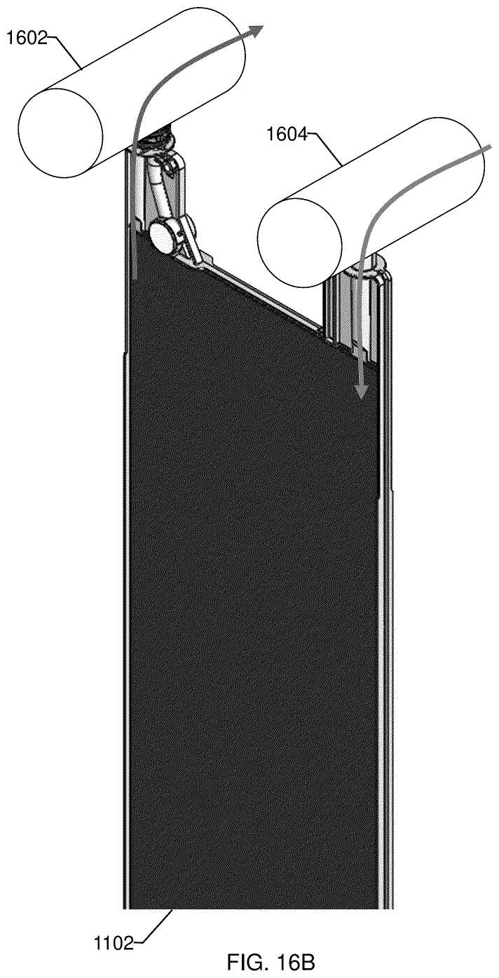

FIG. 15 is a flow chare of an exemplary method 1550 for fabricating a discharge cathode assembly (e.g., the discharge cathode assembly 1001 of FIG. 10A) of any one or more of the metal-air batteries described herein. The exemplary method 1550 establishes a sealed electrical connection between the gas diffusion electrode (GDE) and an external terminal while maintaining the integrity of the enclosed air cavity.

As shown in step 1552, the exemplary method 1550 may include forming a frame of electrically insulating material onto a terminal with a first end portion of the terminal exposed in a window defined by the frame and a second end portion of the terminal outside of the frame. The frame may serve as both a structural support and an insulating barrier, providing mechanical stability while electrically isolating components of the discharge cathode assembly. The terminal may be overmolded into the frame such that a portion of the terminal remains accessible through the window to facilitate electrical connection. The frame material may include thermoplastics such as polypropylene, polyether ether ketone (PEEK), or other polymer composites designed to withstand electrochemical and environmental stresses.

As shown in step 1554, the exemplary method 1550 includes positioning a gas diffusion electrode (GDE) on the frame with a busbar supported on the GDE and a bus tab extending from the busbar to the window. The busbar may serve as the primary electrical conduit, collecting current from the GDE and routing the current toward the terminal connection point. The bus tab may be an extension of the busbar and may bridge the electrical connection between the GDE and the exposed terminal segment. Proper alignment of the busbar and the bus tab may facilitate achieving efficient charge transfer while reducing resistance losses.

As shown in step 1556, the exemplary method 1550 may include connecting the bus tab and the first end portion of the terminal to one another through the window. This step establishes the electrical continuity of the discharge cathode assembly, allowing current to flow from the GDE, through the busbar and bus tab, and into the terminal. Various connection techniques may be used, including resistance welding, laser welding, ultrasonic welding, soldering, conductive adhesives, or mechanical fastening methods such as crimping or riveting. The connection process may be controlled to create a low-resistance electrical joint while ensuring mechanical stability to withstand operational stresses.

As shown in step 1558, the exemplary method 1550 may include, with the bus tab and the terminal connected to one another, hermetically sealing the window. The sealing preserves the enclosed air cavity within the gas diffusion electrode, reducing the likelihood of ingress of moisture, contaminants, or unwanted gases that could otherwise degrade electrochemical performance of the gas diffusion electrode. The sealing process may include attaching a cap over the window using ultrasonic welding, laser welding, hot plate welding, impulse welding, adhesive bonding, or potting with a cured polymer material.

The previous sections detailed methods for forming sealed electrical connections within gas diffusion electrodes, including the integration of busbars, the welding of electrical terminals, and the sealing of windows to maintain the integrity of the enclosed air cavity. These features facilitate achieving reliable electrical connectivity while preserving the electrochemical environment necessary for stable long-term operation. In addition to improving the electrical and structural aspects of gas diffusion electrodes, further improvements can be made to enhance electrode performance and longevity by addressing oxygen distribution during operation.

Gas diffusion electrodes rely on a controlled supply of oxygen to facilitate electrochemical reactions. However, when oxygen is delivered through a fixed manifold or flow field, differences in concentration can develop between the inlet and outlet regions. This imbalance can lead to localized over-discharging or under-discharging, resulting in uneven electrode degradation over time. To mitigate this effect, the following embodiments introduce alternating airflow direction to improve oxygen distribution within the gas diffusion electrode. By dynamically adjusting airflow pathways, the system reduces concentration gradients and promotes uniform reaction conditions across the electrode surface.

Referring now to FIGS. 16A and 16B, a first air passage 1602 and a second air passage 1604 may be used to supply air to the gas diffusion electrode 1102 in two alternating directions. As compared to a single direction of air flow over a gas diffusion electrode, the alternating air flow directions over the gas diffusion electrode 1102 may be useful for reducing variation in oxygen delivery along the gas diffusion electrode 1102, thus facilitating robust performance of the gas diffusion electrode 1102 over longer periods. As may be appreciated, such improvement in long-term performance achievable by the gas diffusion electrode 1102 may, in turn, contribute to long-term performance robustness of an electrochemical cell (e.g., the electrochemical cell 400 in FIG. 4A) including the gas diffusion electrode 1102.

In general, the first air passage 1602 and the second air passage 1604 may each be positioned on opposite sides of the gas diffusion electrode 1102 such that oxygen (e.g., from air) may be supplied from either direction, depending on the operational mode of a discharge cathode assembly (e.g., the discharge cathode assembly 1001 in FIG. 10A) including the gas diffusion electrode 1102. Switching the direction of air flow through the gas diffusion electrode 1102 may be useful, for example, for addressing issues associated with fixed airflow manifolds, where oxygen concentration tends to decrease along the length of the electrode due to consumption in electrochemical reactions. By alternating which of the first air passage 1602 and the second air passage 1604 serves as the inlet for air flow through the gas diffusion electrode 1102, portions of the gas diffusion electrode 1102 receiving fresh oxygen may be changed, reducing the oxygen concentration gradients along the gas diffusion electrode 1102. That is, as compared to a fixed air flow path, alternating which of the first air passage 1602 and the second air passage 1604 serves as the inlet for air flow may reduce the likelihood that regions of the gas diffusion electrode 1102 experience persistent over-discharging or under-discharging, thus improving longevity of the gas diffusion electrode 1102 and contributing to uniform electrochemical performance of the gas diffusion electrode 1102 through the life of the gas diffusion electrode 1102.

Further or instead, each air flow pathway may facilitate achieving even distribution of oxygen across the surface of the gas diffusion electrode 1102 while also achieving low pressure drop along each flow path. As compared to a fixed air flow path, altering air flow directions through the first air passage 1602 and the second air passage 1604 may improve stability of the electrochemical reaction environment, reducing localized degradation and enhancing the overall efficiency of the gas diffusion electrode 1102. As described in greater detail below, the first air passage 1602 and the second air passage 1604 may be connected to separate air flow control systems, such as independently operable air movers, may share a common air flow source, and/or may be regulated by one or more directional valves.

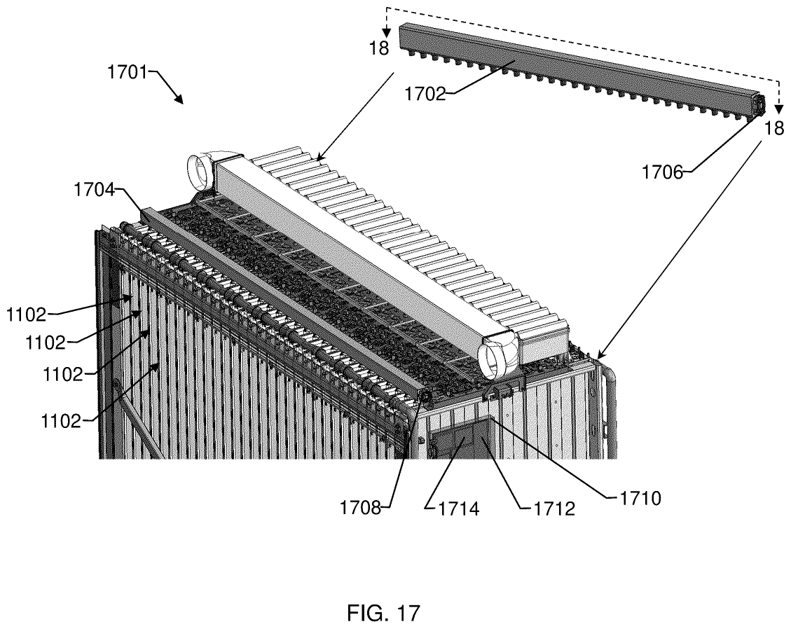

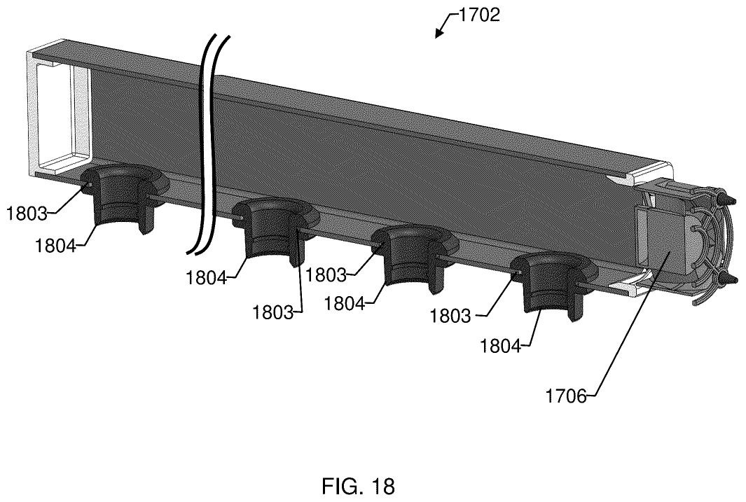

Referring now to FIGS. 17 and 18, a module 1701 of electrochemical cells may include a plurality of instances of the gas diffusion electrode 1102, a first manifold 1702, and a second manifold 1704. The first manifold 1702 may include a first air mover 1706 and further, or instead, the second manifold may include a second air mover 1708. The first air mover 1706 may be any one or more of a fan or blower. Similarly, the second air mover 1708 may be any one or mor of a fan or blower. In certain implementations, the first manifold 1702 and the second manifold 1704 may each be in fluid communication with each instance of the gas diffusion electrode 1102 in the module 1701 via a respective instance of a port 1803 defined by the respective manifold. Continuing with this example, the first air mover 1706 and the second air mover 1708 may be toggled on and off such that air flow to each instance of the gas diffusion electrode 1102 may be alternated as discussed above with respect to FIGS. 16A and 16B. Unless otherwise specified or made clear from the context, it shall be appreciated that the first manifold 1702 and the second manifold 1704 may be identical to facilitate achieving consistency in reversing air flow across the plurality of instances of the gas diffusion electrode 1102. Thus, for the sake of clear and efficient description, only a cross-section of the first manifold 1702 is shown in FIG. 18.

While the direction of air flow through each instance of the gas diffusion electrode 1102 may be controlled by toggling the first air mover 1706 and the second air mover 1708, it shall be appreciated that other techniques may be additionally or alternatively used.

For example, in some instances, the first air mover 1706 may be reversible such that the direction of air flow through the plurality of instances of the gas diffusion electrode 1102 may be controlled by reversing direction of the first air mover 1706 to form positive or negative pressure in the first manifold 1702. Continuing with this example, the second manifold 1704 may be implemented without a dedicated air mover, and the direction of flow through the second manifold 1704 may be controlled by the first air mover 1706 in fluid communication with the second manifold 1704 via the plurality of instances of the gas diffusion electrode 1102.

As another example, an instance of a valve 1804 may be disposed in each respective instance the port 1803 defined by the first manifold 1702 and/or in each respective instance of the port 1803 defined by the second manifold 1704. According to this example, a plurality of instances of the valve 1804 may be controlled such that the direction of airflow through each instance of the gas diffusion electrode 1102 may be controlled individually. That is, through selective activation and/or deactivation of the plurality of instances of the valve 1804 disposed in the respective plurality of instances of the port 1803 defined by the first manifold 1702 and/or in the plurality of instances of the port 1803 defined by the second manifold 1704, the direction of air flow through each instance of the gas diffusion electrode 1102 may be controlled separately relative to the direction of air flow through the other instances of the gas diffusion electrode 1102. For example, the direction of air flow through the plurality of instances of the gas diffusion electrode 1102 may be controlled such that sequential instances of the gas diffusion electrode 1102 in the module 1701 are opposite one another, as may be useful for balancing thermal management and/or other performance parameters of a plurality of electrochemical cells operating together in the module 1701.

Each instance of the valve 1804 may be passively and/or actively controllable. For example, one or more instances of the valve 1804 may be an individually controllable active valve, such as solenoid-operated or motorized valves, as may be useful for precise regulation of air flow into different instances of the gas diffusion electrode 1102 in the module 1701. That is, individually and/or selectively operable instances of the valve 1804 may facilitate dynamically adjusting oxygen distribution, improving performance of the plurality of instances of the gas diffusion electrode 1102, improving performance of an anode operating as part of an electrochemical cell including the gas diffusion electrode 1102, and/or extending operational lifespan of an electrochemical cell including the gas diffusion electrode 1102. Alternatively, or in addition, one or more instances of the valve 1804 may be a pressure-sensitive valve, which opens or closes in response to differential pressure across the valve 1804 (e.g., in response to differential pressure in the first manifold 1802 relative to the gas diffusion electrode 1102, in instances in which the valve 1804 is in the first manifold 1802). As compared to actively controlled valves, passively operable valves may reduce, or even eliminate, the need for external control mechanisms for achieving alternating airflow patterns. In certain implementations, these passively controllable valves may function as one-way check valves, allowing flow in a preferred direction while preventing or substantially limiting (less than about 5% of total flow) backflow or unintended mixing of gases.

While alternating air flow has been shown with respect to two manifolds each including an air mover, it shall be appreciated that other air flow arrangements are additionally or alternatively possible. For example, in some instances, a single air mover may be used and switching may be used to direct air flow through the first manifold 1802 and the second manifold 1704 to achieve the alternating flow patterns discussed herein.

In certain implementations, the module 1701 may include a controller 1710 including a processing unit 1712 and non-transitory computer-readable storage media 1714 in electrical communication with one another. The processing unit 1712 may be in electrical communication (e.g., wired or wireless) with one or more of the first air mover 1706, the second air mover 1708, or the valves 1804. In general, the non-transitory computer-readable storage media 1714 may have stored thereon instructions for causing the processing unit 1712 to carry out any one or more of the techniques described herein for controlling air flow to the plurality of instances of the gas diffusion electrode 1102.

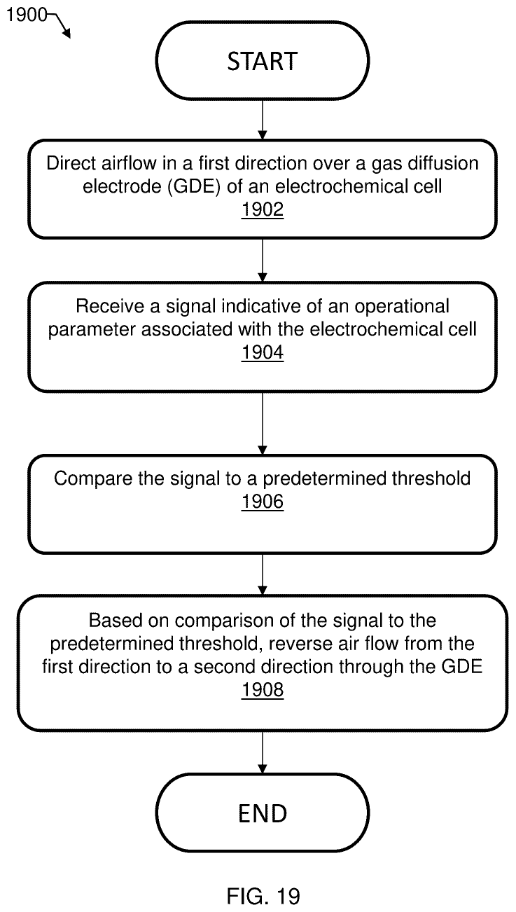

FIG. 19 is a flow chart of an exemplary method 1900 for controlling air flow through a discharge cathode assembly. The exemplary method 1900 may dynamically regulate oxygen distribution within the gas diffusion electrode (GDE) of an electrochemical cell to maintain stable operating conditions, mitigate localized over-discharging or under-discharging, and extend electrode lifespan. Unless otherwise specified or made clear from the context, any one or more aspects of the exemplary method 1900 may be carried out on any one or more of the discharge cathode assemblies described herein to control air flow to any one or more of the gas diffusion electrodes described herein. As an example, any one or more aspects of the exemplary method 1900 may be carried out by the controller 1710 (FIG. 17), with the processing unit 1712 (FIG. 17) carrying out instructions stored on the non-transitory computer-readable storage media 1714 (FIG. 17).

As shown in step 1902, the exemplary method 1900 may include directing air flow in a first direction over a gas diffusion electrode (GDE) of an electrochemical cell. The airflow may be supplied via a manifold, a blower system, or other gas delivery mechanisms that may provide oxygen to the GDE. The flow direction may initially supply oxygen through one of a plurality of air passages, such as through a first manifold or a second manifold, while maintaining controlled exhaust at another one of the plurality of air passages.

As shown in step 1904, the exemplary method 1900 may include receiving a signal indicative of an operational parameter associated with the electrochemical cell. This signal may be generated by one or more sensors monitoring variables such as oxygen concentration, cell voltage, current density, gas pressure, or temperature within the GDE, within the electrochemical cell containing the GDE, and/or within a module of electrochemical cells in which the GDE is operating. The signal may, for example, continuously evaluate system conditions to determine whether an adjustment in airflow direction is necessary or advantageous for improving performance of the electrochemical cell.

As shown in step 1906, the exemplary method 1900 may include comparing the signal to a predetermined threshold. In certain implementations, the predetermined threshold may be based on empirical data or real-time calculations indicative of target (e.g., optimal) operating conditions of the electrochemical cell. For example, the signal may be compared to a predetermined threshold of oxygen concentration near the exhaust flow passage of the GDE. Further, or instead, the signal may be compared to cell voltage fluctuations indicative of uneven reaction distribution.

As shown in step 1908, the exemplary method 1900 may include, based on comparison of the signal to the predetermined threshold, reversing air flow from the first direction to a second direction through the GDE. This reversal may be achieved using any one or more of the active control techniques described herein, such as modulating one or more air movers, switching airflow through actively controlled valves, and/or activating secondary manifolds to redirect movement of air through the GDE. Alternating the air flow pattern through the GDE in this way may, for example, reduce the likelihood of persistent oxygen concentration gradients, thus increasing the likelihood of uniform reaction conditions across the GDE and, in turn, reducing the likelihood of premature degradation of the GDE and other components of the electrochemical cell.

The exemplary method 1900 may be implemented, for example, in a closed-loop control system, in which adjustments to air flow occur automatically (e.g., based on real-time sensor feedback) or in a semi-automated configuration (e.g., an operator or external control logic determines when to reverse air flow). By periodically alternating air flow direction through the GDE, the exemplary method 1900 may enhance the stability and durability of the gas diffusion electrode, improving overall electrochemical performance in metal-air battery systems and other energy storage applications.

The above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

Embodiments disclosed herein may include computer program products comprising computer-executable code or computer-usable code that, when executing on one or more computing devices, performs any and/or all of the steps of the control systems described above. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the control systems described above may be embodied in any suitable transmission or propagation medium carrying computer-executable code and/or any inputs or outputs from the same.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

What is claimed is:

1. A method of fabricating a discharge cathode assembly of a metal-air battery, the method comprising:
forming a frame of electrically insulating material onto a terminal with a first end portion of the terminal exposed in a window defined by the frame and a second end portion of the terminal outside of the frame;
positioning a gas diffusion electrode (GDE) on the frame with a busbar supported on the GDE and a bus tab extending from the busbar to the window;
connecting the bus tab and the first end portion of the terminal to one another through the window; and
with the bus tab and the terminal connected to one another, hermetically sealing the window.

2. The method of claim 1, forming the frame of electrically insulating material onto the terminal includes overmolding the frame of electrically insulating material onto the terminal.

3. The method of claim 1, wherein the electrically insulating material of the frame is plastic.

4. The method of claim 1, wherein positioning the GDE on the frame includes feeding the bus tab into contact with the first end portion of the terminal via a slot extending from the GDE to the window.

5. The method of claim 1, wherein positioning the GDE on the frame includes bonding the GDE to the frame.

6. The method of claim 1, wherein connecting the bus tab and the first end portion of the terminal to one another through the window includes welding the bus tab and the first end portion of the terminal to one another through the window.

7. The method of claim 6, wherein welding the bus tab and the first end portion of the terminal to one another includes resistance welding, laser welding, ultrasonic welding, or a combination thereof.

8. The method of claim 1, wherein connecting the bus tab and the first end portion of the terminal to one another includes soldering, applying a conductive adhesive, crimping, or a combination thereof.

9. The method of claim 1, wherein the bus tab and the first end portion of the terminal are connected one another via a fastener.

10. The method of claim 1, wherein hermetically sealing the window includes securing at least one cap to the frame with the at least one cap covering the window.

11. A discharge cathode assembly of a discharge cathode assembly, the discharge cathode assembly comprising:
a frame of an electrically insulating material, the frame defining a slot;
a terminal having a first end portion and a second end portion, the first end portion disposed in the frame and the second end portion extending outside of the frame;
a gas diffusion electrode (GDE) bonded to the frame;
a busbar supported on the gas diffusion electrode; and
a bus tab extending from the busbar to the first end portion of the terminal via the slot, and the bus tab connected to the first end portion of the terminal.

12. The discharge cathode assembly of claim 11, wherein the frame is plastic.

13. The discharge cathode assembly of claim 11, wherein the GDE and the frame are bonded to one another with a hermetic tight seal therebetween.

14. The discharge cathode assembly of claim 11, wherein the bus tab and the first end portion of the terminal are welded to one another.

15. The discharge cathode assembly of claim 11, wherein the bus tab and the first end portion of the terminal are soldered to one another.

16. The discharge cathode assembly of claim 11, wherein the bus tab and the first end portion of the terminal are fastened to one another.

17. The discharge cathode assembly of claim 11, further comprising at least one cap hermetically sealed to the frame, covering connection of the bus tab to the first end portion of the terminal.

18. A method of controlling airflow through a metal-air battery, the method comprising:
directing airflow in a first direction over a gas diffusion electrode (GDE) of an electrochemical cell;
receiving a signal indicative of an operational parameter associated with the electrochemical cell;
comparing the signal to a predetermined threshold; and
based on comparison of the signal to the predetermined threshold, reversing air flow from the first direction to a second direction through the GDE.

19. The method of claim 18, wherein the GDE is sealed in a frame defining a first air passage and a second air passage, and directing airflow in the first direction over the GDE includes moving air over the GDE generally from the first air passage to the second air passage.

20. The method of claim 18, wherein the operational parameter associated with the electrochemical cell is operating time.
